(19) United States
(12) Patent Application Publication
(10) Pub. No.: US 2012/0308437 A1
(43) Pub. Date: Dec. 6, 2012

(54) Detector Module, a Method for Controlling the Detector Module and a Detection System

(76) Inventors: Xiaoqun Zhou, Singapore (SG); Soon Huat Ng, Singapore (SG)

(21) Appl. No.: 13/515,559

(22) PCT Filed: Dec. 10, 2010
(86) PCT No.: PCT/SG2010/000461

§ 371 Date: Aug. 27, 2012

(30) Foreign Application Priority Data
Dec. 14, 2009 (SG) 200908314-8

(51) Int. Cl. G01N 21/75

(52) U.S. Cl. 422/82.05

(57) ABSTRACT

According to embodiments of the present invention, a detector module is provided. The detector module includes: a chip configured to receive at least one specimen; a first light-emitting diode configured to illuminate the at least one specimen; and a first photodetector configured to detect light emitted from the at least one illuminated specimen. According to further embodiments, a detection system is provided. The detection system includes: a detector module; a control module in electrical communication with the detector module; and a pump module configured to collect a sample and transfer the sample to a chip of the detector module.

### CROSS-REFERENCE TO RELATED APPLICATIONS

This application claims the benefit of priority of Singapore application No. 200908314-8, filed 14 Dec. 2009, the content of it being hereby incorporated by reference in its entirety for all purposes.

### TECHNICAL FIELD

Various embodiments relate to a detector module, a method for controlling the detector module and a detection system.

### BACKGROUND

Fluorescence detection systems are increasingly in demand, and in particular for fluorescence based bio-detecting systems. There are generally two types of fluorescence detection methods. One method is the so-called paper strip technique and the other method is the fluorescence analysis method. The former method performs qualitative examination while the latter is based on quantitative analysis.

Fluorescence analysers are commonly used in hospital or clinical laboratories for analysis and detection purposes. However, these analysers are generally very expensive, bulky, and the analysis of samples is time-consuming. These analysers also require trained personnel to operate them manually. Therefore, these analysers are not suitable for home end users.

In addition, generally, fluorescence analysers use a white light source, for example a tungsten lamp or a Xenon lamp, as the excitation light. The white light source emits light in all directions and spanning a relatively broad wavelength range covering the visible light wavelengths. The efficiency of the white light source is low.

### SUMMARY

According to an embodiment, a detector module is provided. The detector module may include: a chip configured to receive at least one specimen; a first light-emitting diode configured to illuminate the at least one specimen; and a first photodetector configured to detect light emitted from the at least one illuminated specimen.

According to an embodiment, a detector module is provided. The detector module may include: a receiving portion configured to receive a chip configured to receive at least one specimen; a first light-emitting diode configured to illuminate the at least one specimen if the chip is received in the receiving portion; and a first photodetector configured to detect light emitted from the at least one illuminated specimen if the chip is received in the receiving portion.

According to another embodiment, a detection system is provided. The detection system may include: a detector module; a control module in electrical communication with the detector module; and a pump module configured to collect a sample and transfer the sample to the chip of the detector module. The detector module may include: a chip configured to receive at least one specimen; a first light-emitting diode configured to illuminate the at least one specimen; and a first photodetector configured to detect light emitted from the at least one illuminated specimen.

According to another embodiment, a method for controlling a detector module is provided. The method may include: receiving at least one specimen in a chip; illuminating the at least one specimen with a light-emitting diode; and detecting light emitted from the at least one illuminated specimen with a photodetector.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIGS. 1A to 1C show schematic block diagrams of a detector module, according to various embodiments.

FIG. 1D shows a perspective view of a detector module, according to one embodiment.

FIG. 1E shows a perspective view of a detector module, according to another embodiment.

FIG. 1F shows a simplified schematic diagram of the detector module of the embodiment of FIG. 1D.

FIG. 1G shows a simplified schematic diagram of a detector module, according to one embodiment.

FIG. 1H shows a simplified schematic diagram of a detector module, according to one embodiment.

FIG. 1I shows a simplified schematic diagram of a detector module, according to one embodiment.

FIG. 2 shows a schematic diagram of a control module, according to one embodiment.

FIG. 3 shows a schematic diagram of a pump module, according to one embodiment.

FIG. 4A shows a schematic diagram of an automated detection system, according to one embodiment.

FIG. 4B shows a schematic diagram of a portable detection system, according to one embodiment.

FIG. 4C shows a schematic diagram of a portable detection system, according to one embodiment.

FIG. 5 shows a flow chart illustrating a method for controlling a detector module, according to various embodiments.

FIG. 6 shows a perspective view of an auto-sampling system, according to one embodiment.

FIG. 7 shows a schematic diagram of an auto-sampling multiplexed detection system, according to one embodiment.

FIG. 8 shows a perspective view of a toilet seat employing a detection system, according to one embodiment.

FIG. 9 shows a schematic diagram of a reaction of a dye with an analyte to form a fluorophor, according to one embodiment.

FIG. 10 shows a schematic diagram of a fluorescence detection and analysis system, according to various embodiments.

FIG. 11 shows a schematic view of an information system, according to various embodiments.

FIG. 12 shows a plot of protein concentration and fluorescence intensity, according to various embodiments.

FIG. 13 shows a plot of protein concentration and voltage, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Various embodiments may provide a detector module for receiving at least one specimen, exciting the at least one specimen and detecting the fluorescence emitted from the at least one excited specimen.

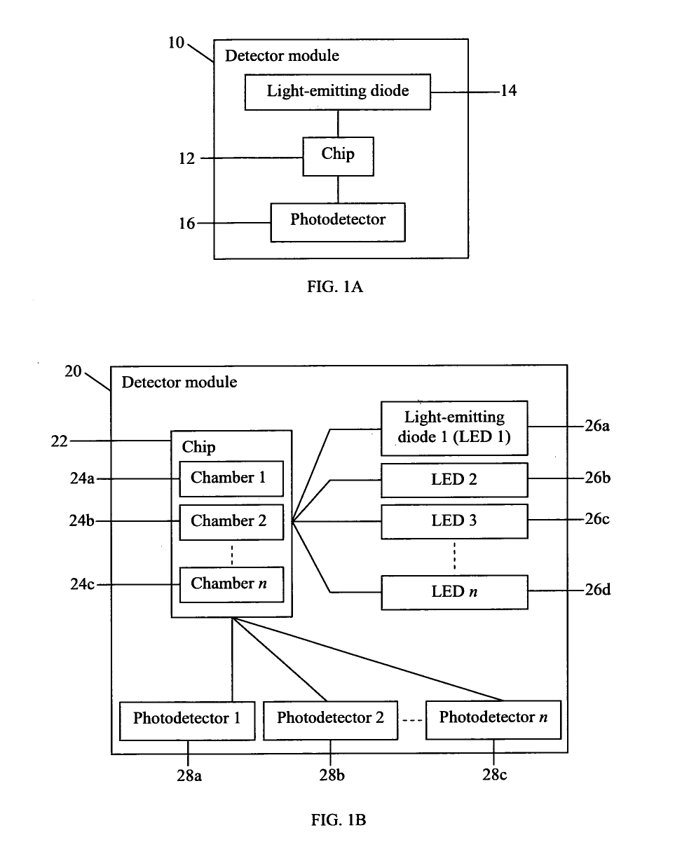

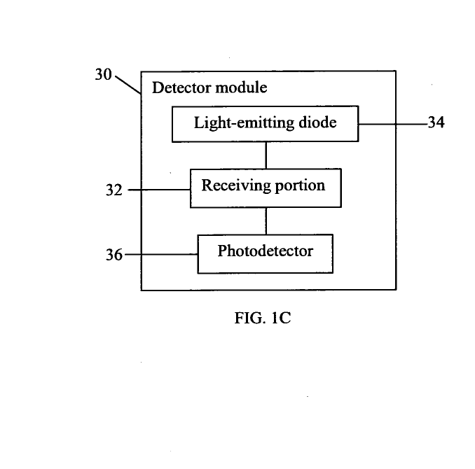

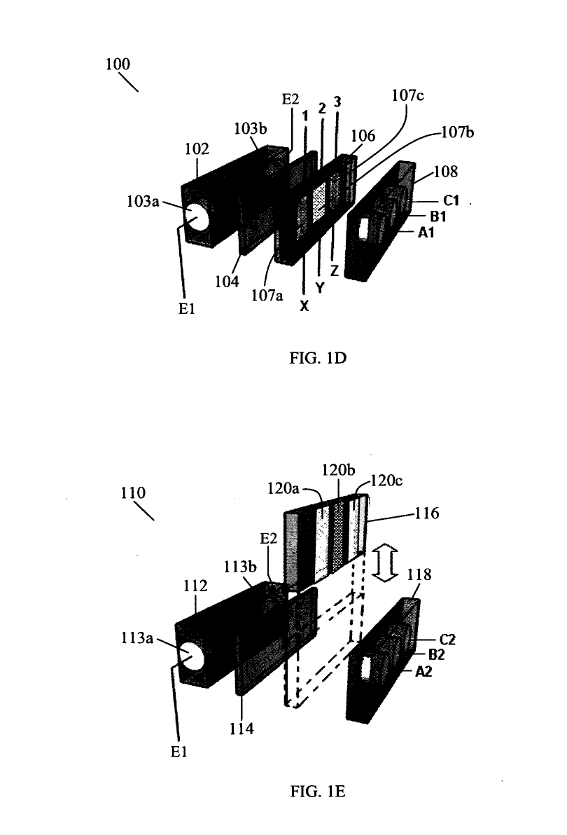

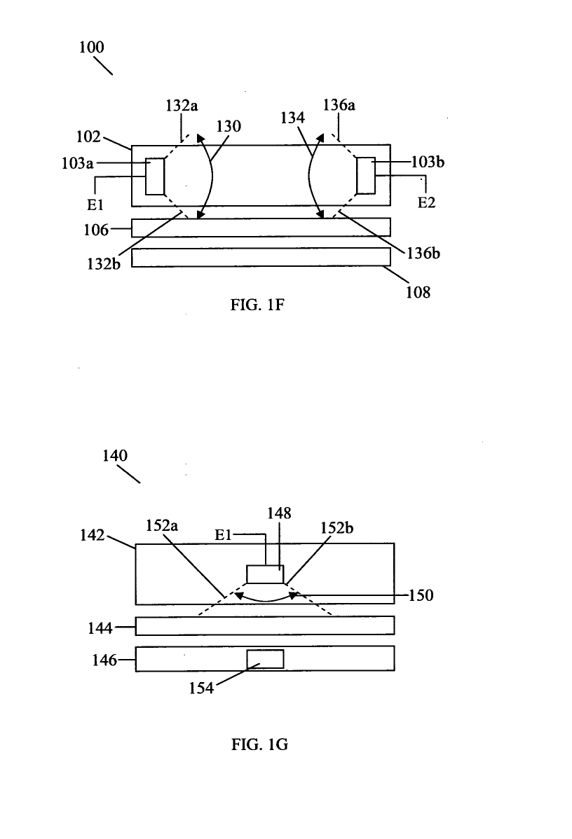

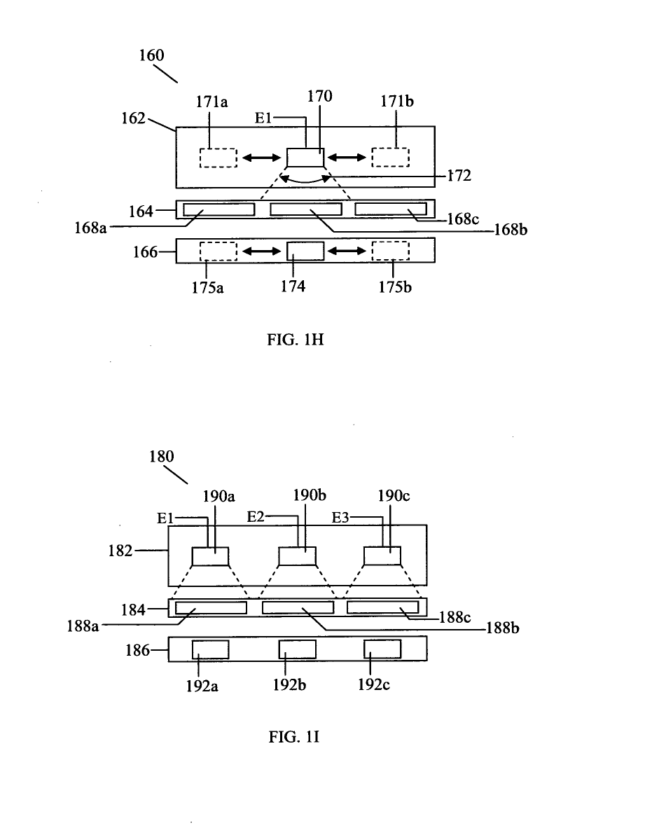

FIG. 1A shows a schematic block diagram of a detector module 10, according to one embodiment. The detector module 10 may include a chip configured to receive at least one specimen, a first light-emitting diode 14 configured to illuminate the at least one specimen and a first photodetector 16 configured to detect light emitted from the at least one illuminated specimen. In various embodiments, illuminating the at least one specimen may cause excitation of the at least one specimen. As a result, the at least one illuminated specimen, which may be in an excited state, may fluoresce and emit light (eg. fluorescence). In various embodiments, the first light-emitting diode 14 may be at least substantially aligned to the first photodetector 16.

FIG. 1B shows a schematic block diagram of a detector module 20, according to one embodiment. The detector module 20 may include a chip 22 configured to receive at least one specimen. The at least one specimen may be a plurality of specimens, for example two specimens, three specimens or any number of specimens. The chip 22 may include at least one chamber or a plurality of chambers to receive the at least one specimen. The plurality of chambers may include a first chamber 24a, a second chamber 24b or any number of chambers 24c configured to receive the at least one specimen, or wherein each chamber of the first chamber 24a, the second chamber 24b or any number of chambers 24c is configured to receive a respective specimen of the at least one specimen. The respective specimen in the first chamber 24a, the second chamber 24b or any number of chambers 24c may be the same specimen or may be different specimens.

The detector module 20 may include a first light-emitting diode (LED) 26a, a second LED 26b, a third LED 26c and any number of LED 26d, configured to illuminate the at least one specimen. The first LED 26a may be configured to illuminate a first specimen of the at least one specimen, the second LED 26b may be configured to illuminate a second specimen of the at least one specimen and the third LED 26c may be configured to illuminate a third specimen of the at least one specimen. The first specimen, the second specimen and the third specimen may be the same specimen or different specimens.

The detector module 20 may include a first photodetector 28a, a second photodetector 28b and any number of photodetector 28c configured to detect light emitted from the at least one illuminated specimen. The first photodetector 28a may be configured to detect light emitted from a first specimen of the at least one illuminated specimen and the second photodetector 28b may be configured to detect light emitted from a second specimen of the at least one illuminated specimen.

While not illustrated in FIG. 1B, it should be appreciated that each of the first LED 26a, the second LED 26b, the third LED 26c and any number of LED 26d may be aligned to each of the first photodetector 28a, the second photodetector 28b and any number of photodetector 28c.

FIG. 1C shows a schematic block diagram of a detector module 30, according to one embodiment. The detector module 30 may include a receiving portion 32 configured to receive a chip configured to receive at least one specimen, a first light-emitting diode 34 configured to illuminate the at least one specimen if the chip is received in the receiving portion 32, and a first photodetector 36 configured to detect light emitted from the at least one illuminated specimen if the chip is received in the receiving portion 32. In various embodiments, the first light-emitting diode 34 may be at least substantially aligned to the first photodetector 36.

It should be appreciated that the detector module 30 may include any number of light-emitting diodes (LED) and/or any number of photodetectors, in a substantially similar configuration as the embodiment illustrated in FIG. 1B.

In various embodiments, the detector module 10, 20, 30, may be included in a detection system, integrated with other modules, for example a control module and/or a pump module, for detecting an analyte or analytes in a sample and consequently the specimen.

Various embodiments may provide a detection system, such as a bio-sensing system, for performing quantitative analysis of a sample, for example a urine sample, to serve as an early warning and monitoring system for early detection and monitoring of particular illnesses and diseases for the end users, in particular the end users at home. This may facilitate early diagnosis, monitoring and timely treatment of illnesses and diseases. In addition, the various embodiments may allow the end users to benefit from a saving in time and money compared to making visits to the hospitals.

Various embodiments may provide an automated, battery powered and/or portable detection or bio-sensing detection system, for example for end users at home, to rapidly identify and measure the amount of certain target analytes or biomarkers in a sample, for example proteins in urine, that may serve as indicators for the presence of certain diseases, such as renal failure, etc.

Various embodiments may facilitate early diagnosis, monitoring and timely treatment of illnesses and diseases, by performing screening tests with the detection system. One of the screening tests that may be employed is urinalysis, which checks for traces of proteins in urine and determines the amount of the proteins present. Such a test may serve as an early warning mechanism for potential kidney problems and a monitoring system for chronic patients.

Generally, the presence of proteins in the urine (proteinuria) may be an early sign of renal (kidney) damage. Since serum proteins are readily reabsorbed from urine, the presence of excess protein indicates either an insufficiency of absorption or impaired filtration. The most common cause of proteinuria is diabetes. However, proteinuria may occur also in one of the following conditions: nephrotic syndromes (i.e. intrinsic renal failure), pre-eclampsia, eclampsia, toxic lesions of kidneys, collagen vascular diseases (e.g. systemic lupus erythematosus), dehydration, glomerular diseases, such as membranous glomerulonephritis, focal segmental glomerulonephritis, minimal change disease (lipoid nephrosis), focal segmental glomerulosclerosis (FSGS), IgA nephropathy (i.e. Berger's disease), IgM nephropathy, membranoproliferative glomerulonephritis, membranous nephropathy, sarcoidosis, Alport's syndrome, Fabry's disease, aminoaciduria, Fanconi syndrome, hypertensive nephrosclerosis, interstitial nephritis, sickle cell disease, hemoglobinuria, multiple myeloma, myoglobinuria, organ rejection, Ebola hemorrhagic fever, Wegener's granulomatosis, rheumatoid arthritis, glycogen storage diseases, and Goodpasture's syndrome.

Another cause for proteinuria are viral or bacterial infections, such as HIV, syphilis, hepatitis, and streptococcal infection.

For example, Streptococcus may cause a person to have acute kidney failure or turn a chronic kidney problem into an acute kidney failure. A person with stable kidney disease may suddenly get worse when there is a precipitating factor. Even a healthy person, who has an infection, may develop kidney failure due to the presence of streptococcus in blood. In early stages, patients normally have no clinical symptoms. However, in order to avoid permanent damage, it is essentially to identify a potential condition as soon as possible. By employing the suitable screening test, the detection system of various embodiments may provide the users with an early diagnosis of the respective condition.

Various embodiments may provide a multiplexed detection system or a multiplexed detection bio-sensing system with two different configurations. The users of the system may either choose to employ an auto-sampling system for collecting the sample, for example urine, and complete the screening test automatically or use a disposable chip to collect or absorb the sample, for example urine, manually.

Various embodiments may further incorporate an imbedded information system, such that test results may be wirelessly sent or transmitted to a private doctor, clinical centres, databases and/or remote devices, such as a handheld unit or a remote controller for the detection system, a display unit, a processing unit, a storage unit or a combination thereof. In various embodiments, the imbedded information system may also receive a communication response wirelessly.

Various embodiments may provide a detection system with automated sample collection, a fluidic control system, a light source, a fluorescence detection module and a control and information system.

Various embodiments may provide a detection system with a light source including one or more light-emitting diodes (LEDs). An LED may emit light having specific emission wavelengths or a specific emission wavelength range. In addition, an LED emits light in a particular direction. In other words, an LED provides a directional output or light emission. In various embodiments, the directional light emission from the LED or LEDs may cover a wide range of emission angles, for example between about 10° to about 90°, such as between about 10° to about 70°, between about 10° to about 50°, between about 30° to about 90°, between about 30° to about 70° or between about 15° to about 30°, such that the emission angle may be about 15°, about 20°, about 30°, about 45°, about 60° or about 90°.

In one embodiment, the light source may include one LED. In other embodiments, the light source may include a plurality of LEDs, for example, two LEDs, three LEDs, four LEDs or five LEDs or any number of LEDs. The LEDs may have the same emission wavelengths or different emission wavelengths. In further embodiments, the LEDs may be tunable. For example, the LEDs may have relatively broad emission wavelengths, such that the LEDs may be tuned to provide specific emission wavelengths, being a portion of the relatively broad emission wavelengths, at any one time.

In various embodiments, blue diodes, ultra-violet (UV) diodes with an emission wavelength range of approximately 340 nm-380 nm, and white light diodes may be used as the light source or the excitation light source. It should be appreciated that any light-emitting diode having a specific emission wavelength range may be used, depending on the type of screening test, the sample or the analytes in the sample or the dye used and consequently the fluorophors formed. For example, a compact blue laser diode having an emission wavelength range of approximately 405±10 nm may be used as the excitation light source for inducing fluorescence from the reaction products or fluorophors formed between fluorescamine with primary amines.

In various embodiments, the light source used may depend on the dye used, and hence the fluorescence or light emitted from the illuminated specimen. In the case of organic dyes, the excitation wavelength and the emission wavelength may be substantially close to each other within the wavelength range of about 400 nm-700 nm. For example, the cyanine dye, Cy3, requires excitation at about 550 nm and produces emission at about 570 nm. Therefore, it may be challenging to distinguish between the excitation and emission lights and to provide an optical system to distinguish the two emissions.

Therefore, in various embodiments, the light source may be chosen such that a difference of at least 40 nm between the central position of the emission wavelength range from the light source and the central position of the wavelength range of the light emitted from the illuminated specimen, may be provided in order to minimize crosstalk and to distinguish between the excitation light for illuminating the specimen and the emission light from the illuminated specimen.

In various embodiments, the dye used in the detection system of various embodiments may be a quantum dot (QD) dye. QD dyes may be tunable and may have an excitation wavelength below 400 nm and an emission wavelength in the range of about 500 nm-680 nm. In various embodiments, the QD dyes may be cadmium selenide (CdSe), cadmium telluride (CdTe), zinc selenide (ZnSe), indium phosphide (InP), lead sulphide (PbS) and lead selenide (PbSe).

In various embodiments, any light source may be used as the excitation light source. Each light source may introduce a specific noise pattern and therefore requires an optical system that may be tailored to reduce the noise associated with the light source.

In various embodiments, one LED may be provided to illuminate a specimen. The LED may provide uniform illumination of the specimen. The specimen may be received in a chip. The LED may be arranged with its direction of light emission towards the chip and at least substantially perpendicular to the chip. In various embodiments, the light emission from the LED onto the chip for illumination of the specimen may be at an angle of 90° to the chip. However, it should be appreciated that the light emission may also be at an angle other than 90° to the chip.

In various embodiments, a plurality of LEDs, for example two LEDs, may be provided to illuminate a plurality of specimens, for example two or three specimens. The plurality of LEDs may provide uniform illumination of the plurality of specimens. The plurality of specimens may be received in a chip. The two LEDs may be arranged with their directions of light emissions at least substantially facing each other and being at least substantially parallel to the chip. Furthermore, in such an arrangement, the light emissions from the two LEDs may be projected onto the chip for illumination of the plurality specimens, at angles of approximately 15° to 30°.

In various embodiments, a plurality of LEDs may be provided to illuminate a plurality of specimens, for example two or three specimens, such that each LED is provided to illuminate each specimen. The plurality of specimens may be received in a chip. Each of the plurality LEDs may be arranged with its direction of light emission towards the chip and at least substantially perpendicular to the chip. In various embodiments, the light emission from each of the plurality of LEDs onto the chip for illumination of each of the specimens may be at an angle of 90° to the chip. However, it should be appreciated that the light emissions may also be at an angle other than 90° to the chip.

Various embodiments may provide an auto-sampling detection system or an automated detection system including an auto-sampling system for collecting a sample. The different modules of the detection system may then be automated to perform the screening tests. For example, the detection system may include a pump module for automatically providing, for example, a buffer solution and a detection reagent, to the sample to form a specimen for detection and testing purposes.

Various embodiments may provide a multiplexed detection system or a multiplexed detection bio-sensing system, including an auto-sampling system for collecting the sample and a detector module for detecting fluorescence. The detector module may also convert the optical signals (fluorescence) into electrical signals. For example, the photodetector in the detector module may convert the light emitted from the at least one illuminated specimen and received by the photodetector into an electrical signal. Various embodiments of the multiplexed detection system or the multiplexed detection bio-sensing system may further include a pump module for mixing the sample with a detection reagent that, upon contact with the analyte, forms a detectable species. In various embodiments the detection reagent may be a dye, such as a fluorogenic dye, to form a specimen with the sample collected. The dye may react with a particular analyte in the sample to form a fluorescing adduct (eg. fluorophor). A fluorophor is any molecule in an excited state which is capable of exhibiting fluorescence. Therefore, the reaction between the dye and an analyte resulting in the formation of a fluorophor may enable the detection system of various embodiments to analyse the chemical reaction between the dye and the analyte in the sample.

In various embodiments, the dye may be a quantum dot (QD) dye. The QD dye may be CdSe, CdTe, ZnSe, InP, PbS and PbSe. The QD dye may link with a particular analyte via antibodies (Ab) combining with the relevant antigens (Ag) in the sample. A QD dye is any molecule in an excited state which is capable of exhibiting photo-luminescence when exposed to UV light. The intensity of photo-luminescence is proportional to the concentration of Ag in the sample, and therefore the reaction between the dye and an analyte resulting in the formation of a luminescence may enable the detection system of various embodiments to analyse the chemical reaction between the dye and the analyte in the sample.

In various embodiments, specific antibodies may be provided for binding to specific analytes, for example cancer markers, such as circulating tumour cells (CTCs).

The fluorescence detected may provide an identification of the presence of a particular analyte. Various embodiments of the multiplexed detection system or the multiplexed detection bio-sensing system may further include a control module for controlling the detection system, for data processing and for exchanging data or information with clinical centres, databases and/or remote devices, such as a handheld unit or a remote controller for the detection system of various embodiments, a display unit, a processing unit, a storage unit or a combination thereof. In various embodiments, data processing may include manipulation of the data, analysis of the data, plotting of the data, etc.

In various embodiments, the flow of the sample through the detector system or any module of the detector system may be based on fluidic motion.

In various embodiments, the detection reagent used in the multiplexed detection system or a multiplexed detection bio-sensing system may be a dye, for example a chromogenic or fluorogenic dye, such as fluorescamine. The use of a fluorogenic dye has the advantage that the detectable species is only formed in the presence of the analyte, thus avoiding false positive results and increasing assay sensitivity. Fluorescamine is a non-fluorescent reagent that reacts readily under mild conditions with primary amines in peptides to form stable and relatively highly fluorescent compounds. Therefore, fluorescamine may be suitably used for fluorometric assay of protein. The amino acid derivatives or the fluorescent products, as a result of the reaction between fluorescamine and the primary amines, have an excitation wavelength of approximately 390 nm. This excitation wavelength substantially overlaps with the emission wavelength or output wavelength of compact blue laser diodes of approximately 405±10 nm, which therefore may be used as the excitation light source.

Fluorescamine reacts in seconds with amino acids in a borate buffer to yield a fluorescent product or a fluorophor emitting blue-green fluorescence with a wavelength of about 460-485 nm. In various embodiments, the fluorescence may have a wavelength of about 485 nm. Any un-reacted fluorescamine may be hydrolysed in water to yield a non-fluorescent product, which therefore would not interfere with quantification of the amino acids. Fluorescamine can also increase the detection limit as well as reduce the risk of possible detection errors compared to the use of a fluorescent molecule.

In various embodiments, other fluorogenic dyes which react with primary amines to form fluorescent products may be used. These fluorogenic dyes include, but are not limited to o-phthaldialdehyde (OPA), epicocconone, 5,5′-dithiobis-(2-nitrobenzoic acid) (DNTB) and naphthalene-2,3-dicarboxaldehyde (NDA).

The reaction with OPA is generally performed in a borate buffer with β-mercaptoethanol (HOCH₂CH₂SH) and the fluorescent product has an excitation wavelength of approximately 350 nm.

The reaction with NDA requires the presence of potassium cyanide (KCN) and involves the gradual addition of NDA to the primary amines to prevent precipitation. The resulting fluorescent product has an excitation wavelength of approximately 445 nm.

In various embodiments, the excitation wavelength or the emission wavelength range from the LEDs may be substantially centred at approximately 380 nm, while the wavelength range of the light emitted from the illuminated specimen may be substantially centred at approximately 480 nm. In various embodiments, the difference between the central position of the emission wavelength range from the LEDs and the central position of the wavelength range of the light emitted from the illuminated specimen may be at least 40 nm in order to minimize crosstalk.

In various embodiments, one or more LEDs may be provided, wherein the emission wavelength range of each of the one or more LEDs may be adjustable or tunable to allow flexibility in the choice of the excitation wavelength.

In various embodiments, as a direct chemical reaction is used to label the analytes in the patients' samples, the selectivity of the detection system of various embodiments may be precise, and the sensitivity may be high. In addition, as the reaction time and the analysis time are in the order of several seconds, the detection system of various embodiments may allow fast analysis and allow detection of analytes in the patients' samples at home, thereby catering to the home healthcare market. The detection system of various embodiments may allow the detection of proteins, for example, at levels of 0.01 mg/dl, compared to clinical screen tests, for example by the dip strip method, which may provide readings of 0.15 mg/ml (+) to 0.3 mg/ml (++). Therefore, the detection system of various embodiments may be used an early warning and monitoring system for early detection and monitoring of particular illnesses and diseases for the end users, in particular the end users at home.

Various embodiments may provide a multiplexed detection system or a multiplexed detection bio-sensing system with a flexible diagnostic platform for early warning, detection and monitoring of different illnesses and diseases at home. The detection system may perform a multi-point quantitative analysis of multiple analytes for the same disease or a different disease. Such a multi-point quantitative analysis may be simultaneously performed for multiple analytes.

In addition, the detection system of various embodiments may perform a multi-point quantitative analysis for samples of different patients, by either replacing the test kit or chip and/or logging in to the detection system using a different user identification (user ID) and password.

Furthermore, the detection system of various embodiments may be adapted for analyzing different samples, such as a blood sample and a urine sample, and detection of different diseases. In the context of various embodiments, the term “sample” may refer to an aliquot of material, frequently biological matrices, an aqueous solution or an aqueous suspension derived from biological material. Samples to be assayed for the presence of an analyte by the detection systems of the present invention include, for example, cells, tissues, homogenates, lysates, extracts, and purified or partially purified proteins and other biological molecules and mixtures thereof. Non-limiting examples of samples typically used in the methods of the invention include human and animal body fluids such as whole blood, serum, plasma, cerebrospinal fluid, sputum, bronchial washing, bronchial aspirates, urine, semen, lymph fluids and various external secretions of the respiratory, intestinal and genitourinary tracts, tears, saliva, milk, white blood cells, myelomas and the like; biological fluids such as cell culture supernatants; tissue specimens which may or may not be fixed; and cell specimens which may or may not be fixed. Methods for preparing protein extracts from cells or samples are well known in the art and can be readily adapted in order to obtain a sample that is compatible with the detection systems of the invention.

In various embodiments the sample is urine.

In various embodiments, the analytes to be detected are proteins.

A particular test kit or chip may be used for a particular type of sample such that the detection system may be used to perform different screening tests for different types of samples using different test kits or chips. Accordingly, the detection system of various embodiments may perform different screening tests using the same platform or detection system but with different chips adapted for specific types of samples, for detecting specific types of analytes or for detecting specific illness or disease. In this way, the detection system of various embodiments offers flexibility in performing different screening tests. New screening tests may also be performed using the detection system of various embodiments as and when new or improved test kits or chips are developed for screening new diseases or specific analytes or biomarkers.

For example, for analyzing a blood sample for the detection of certain diseases, a particular test kit or chip for the blood test may be developed and incorporated into the detection system and therefore, the blood test may be carried out using the same platform.

In order to facilitate analysis of different types of samples or analytes or diseases, the detection system of various embodiments may be configured such that the test kit or chip may be detachably arranged in the detection system.

In the context of various embodiments, the term “analyte” may mean a substance or a constituent to be analysed. The analyte may include a biomarker. The biomarker may be an amine, for example a primary amine. In various embodiments, the analyte is a protein or peptide. In other embodiments, the analyte can be a nucleic acid, a hapten, a carbohydrate, a lipid, a cell or any other of a wide variety of biological or non-biological molecules, complexes or combinations thereof. Generally, the analyte will be a protein, peptide, carbohydrate or lipid derived from a biological source such as bacterial, fungal, viral, plant or animal samples. Additionally, however, the target may also be a small organic compound such as a drug, drug-metabolite, dye or other small molecule present in the sample.

In the context of various embodiments, the term “chip” may mean a container or a component configured to receive at least one specimen. The chip may include a test kit or a biochip. The chip may receive the at least one specimen for testing purposes. In various embodiments, the chip may include one or more chambers for receiving the at least one specimen. Each of the one or more chambers may hold the same specimen or a different specimen. Each of the one or more chambers may hold a sample or a specimen having the same analyte or analytes or a different analyte or different analytes.

In various embodiments, the chip may be disposable. The approach of using disposable chips may allow the detection system of various embodiments to be shared by multiple users. This may be facilitated by creating and managing different users' profiles and IDs.

In the context of various embodiments, the term “photodetector” may mean a detector or a sensor of light or other electromagnetic energy. In various embodiments, the photodetector may be, for example any photodiodes, avalanche photodiodes, photomultiplier tubes, photovoltaic cells, photoresistors or photoconductive cells generally known in the art.

In the context of various embodiments, the term “chamber” may mean a chamber or a channel where a solution may flow or pass through or remain in the chamber or channel. In various embodiments, the chamber may be a reaction chamber where chemical reactions may occur. For example, a specimen including a sample and a dye may be provided to the chamber where a reaction between the sample and the dye may occur.

In the context of various embodiments, the term “specimen” may mean a mixture of a sample and any auxiliary or supplementary material, solution or reagent. The auxiliary or supplementary material, solution or reagent may be, for example, a buffer solution or a detection reagent. In various embodiments, the specimen may include a sample and a detection reagent or a sample, a buffer solution and a detection reagent, for example. In various embodiments, the detection reagent may be a dye.

Apart from medical diagnosis, the detection system, the modules of the detection system and the test kits or chips of various embodiments may be adapted for environmental monitoring and for use in other industries, such as the food and beverage industry, the pharmaceutical industry and the chemical industry, among others.

Various embodiments of the multiplexed detection system or the multiplexed detection bio-sensing system may include one or more modules in fluid communication and/or in electrical communication with each other, with each module performing specific functions. Each of the modules may be a detector module, a control module and a pump module. However, it should be appreciated that one or more other modules may be incorporated in the detection system of various embodiments for performing a specific function as and when necessary to perform the required screening test.

In order that the invention may be readily understood and put into practical effect, particular embodiments will now be described by way of examples and not limitations, and with reference to the figures.

FIG. 1D shows a perspective view of a detector module 100, according to one embodiment. The detector module 100 includes a light source 102, a filter 104, a chip 106 and a detecting component 108. In various embodiments, the light source 102, the filter 104, the chip 106 and the detecting component 108 are arranged substantially aligned parallelly with each other.

In various embodiments, the chip 106 may receive a specimen to be tested, the light source 102 may include a light-emitting diode (LED) to illuminate the specimen and the detecting component 108 may include a photodetector to detect light or fluorescence emitted from the illuminated specimen.

In various embodiment, the light source 102 may include one or more light-emitting diodes (LEDs) functioning as the excitation light sources, for example one LED, two LEDs, three LEDs, four LEDs or five LEDs or any number of LEDs. It should be appreciated that any light-emitting diode having a specific emission wavelength range may be used, depending on the type of screening test, the sample or the analytes in the sample, the dye used and consequently the fluorophors formed. For example, a compact blue laser diode having an emission wavelength range of approximately 405±10 nm may be used as the excitation light source for inducing fluorescence from the reaction products or fluorophors formed between fluorescamine with primary amines.

In the embodiment shown in FIG. 1D, the light source 102 includes a first LED 103a and a second LED 103b. The first LED 103a and the second LED 103b may have substantially similar emission wavelengths or different emission wavelengths. Each of the first LED 103a and the second LED 103b, may be in electrical communication with, for example a power source and/or a control circuit, via an electrical interconnection (eg. a wire). For example, the first LED 103a may have a corresponding first electrical interconnection ‘E1’ while the second LED 103b may have a corresponding second electrical interconnection ‘E2’.

The detector module 100 may further include a filter 104 arranged in front of the light source 102 to allow the transmission of light having a wavelength range corresponding to the emission wavelength range of the first LED 103a and the second LED 103b, while blocking the remaining light, such as background light or stray light, which may otherwise interfere with the screening test. In further embodiments, the filter 104 may allow only part of the wavelength range of the emission wavelength from the first LED 103a and the second LED 103b to pass through. In various embodiments, the filter 104 may be any optical filter generally known in the art.

In various embodiments, the chip 106 may include one or more chambers for receiving the specimen. Each of the one or more chambers may receive the specimen with the same fluorophors (ie. based on the same analytes) or different fluorophors (ie. based on different analytes). Providing a different type of fluorophors in each of the chambers may be achieved, for example, by providing a different specimen with its particular analytes with their complementary dye to each of the different chambers, or providing the same specimen to the different chambers and providing a different dye complementary to a specific type of analytes present in the specimen to be detected in each of the different chambers.

In various embodiments, providing the same fluorophors to the different chambers may allow determination of an average reading of the fluorescence resulting from the fluorophors and therefore an indication of the average concentration of the particular analytes in the chambers.

In various embodiments, providing a different type of fluorophors to each of the different chambers may allow simultaneous detection of the different fluorophors.

In the embodiment shown in FIG. 1D, the chip 106 includes a first chamber 107a, a second chamber 107b and a third chamber 107c. Each of the first chamber 107a, the second chamber 107b and the third chamber 107c has an inlet where the specimen may be provided to the chip 106, for example via the first tubing interconnection ‘1’, the second tubing interconnection ‘2’ and the third tubing interconnection ‘3’ connected to the respective inlets of the respective first chamber 107a, second chamber 107b and third chamber 107c. In addition, each of the first chamber 107a, second chamber 107b and third chamber 107c has an outlet where the specimen may be removed from the chip 106, for example via the first tubing interconnection ‘X’, the second tubing interconnection ‘Y’ and the third tubing interconnection ‘Z’ connected to the respective outlets of the respective first chamber 107a, second chamber 107b and third chamber 107c.

It should be appreciated that the chip 106 may have any number of chambers. For example, the chip 106 may have between one to eight chambers, such as one chamber, two chambers, four chambers, six chambers or eight chambers. In various embodiments, the number of chambers in the chip 106 may correspond to the number of types of analytes to be detected. For example, if five different types of analytes are to be detected, five chambers may be provided in the chip. Therefore, each of the five different analytes may be detected from each of the five chambers. Providing a plurality of chambers facilitates the simultaneous detection of different analytes.

In various embodiments, the detector module 100 may include a detecting component 108 for detecting the resulting fluorescence or light emitted from the fluorophors in the first chamber 107a, the second chamber 107b and the third chamber 107c. In the embodiment shown in FIG. 1D, the detecting component 108 includes a first photodetector ‘A1’, a second photodetector ‘B1’ and a third photodetector ‘C1’. Each of the first photodetector ‘A1’, second photodetector ‘B1’ or third photodetector ‘C1’ may be aligned to each of the first chamber 107a, second chamber 107b and third chamber 107c of the chip 106 for detecting fluorescence resulting from the fluorophors in each of the first chamber 107a, second chamber 107b and third chamber 107c. In such an arrangement, the detection system with the first photodetector ‘A1’, second photodetector ‘B1’ and third photodetector ‘C1’ may detect fluorescence from fluorophors in the first chamber 107a, second chamber 107b and third chamber 107c respectively.

It should be appreciated that the detector module 100 may have any number of photodetectors, for example between one to eight photodetectors, such as one photodetector, two photodetectors, four photodetectors, six photodetectors or eight photodetectors. In various embodiments, the number of photodetectors in the detector module 100 may correspond to the number of chambers of the chip 106. For example, if five chambers are provided in the chip 106, five photodetectors may be provided in the detector module 100, such that each of the five different photodetectors is aligned with each of the five different chambers to detect fluorescence emanating from the respective chamber.

In various embodiments, the detector module 100 may further include a filter placed in front of the detecting component 108 to allow the transmission of light having a wavelength range corresponding to the light emitted from the illuminated specimen, while blocking the remaining light, such as background light or stray light or the excitation light, in order to minimize crosstalk which may otherwise interfere with the screening test. In addition, this filter may allow only part of the wavelength range of the light emitted from the illuminated specimen to pass through.

In various embodiments, the first photodetector ‘A1’, the second photodetector ‘B1’ and the third photodetector ‘C1’ may receive or detect the optical signals or light emitted from the illuminated specimen in the form of fluorescence and convert the optical signals or light emitted from the illuminated specimen into electrical signals for further processing.

FIG. 1E shows a perspective view of a detector module 110, according to another embodiment. The detector module 110 includes a light source 112, a filter 114, a chip 116 and a detecting component 118. In various embodiments, the light source 112, the filter 114, the chip 116 and the detecting component 118 are arranged substantially aligned parallelly with each other. As the filter 114 of the detector module 110 is substantially similar and perform substantially the same function as the corresponding filter 104 in the detector module 100, the descriptions of the functions, operations and various embodiments of the filter 114 will not be presented here as the explanation with regard to the filter 104 may be similarly applicable here for the filter 114.

In the embodiment shown in FIG. 1E, the light source 112 includes a first LED 113a and a second LED 113b. The first LED 113a and the second LED 113b may have substantially similar emission wavelengths or different emission wavelengths. Each of the first LED 113a and second LED 113b, may be in electrical communication with, for example a power source and/or a control circuit, via an electrical interconnection (eg. a wire). For example, the first LED 113a may have a corresponding first electrical interconnection ‘E1’ while the second LED 113b may have a corresponding second electrical interconnection ‘E2’. As the configuration and function of the light source 112 are substantially similar to the light source 102 in the detector module 100, the descriptions of the functions, operations and various embodiments of the light source 112 will not be presented here as the explanation with regard to the light source 102 may be similarly applicable here for the light source 112.

In the embodiment shown in FIG. 1E, the chip 116 includes a first chamber 120a, a second chamber 120b and a third chamber 120c. Each of the first chamber 120a, second chamber 120b and third chamber 120c, has an inlet and an outlet, similar to that described for chip 106 of the detector module 100. In various embodiments, the chip 116 may be detachably arranged in the detector module 110. For example, the chip 116 may be removed from the detector module 110, for example for disposal, or positioned substantially aligned with the light source 112, the filter 114 and the detecting component 118, for testing and detection purposes.

In various embodiments, the detector module 110 may include a detecting component 118 for detecting the resulting fluorescence from the fluorophors. In the embodiment shown in FIG. 1E, the detecting component 118 includes a first photodetector ‘A2’, a second photodetector ‘B2’ and a third photodetector ‘C2’. As the configuration and function of the detecting component 118 are substantially similar to the detecting component 108 in the detector module 100, the descriptions of the functions, operations and various embodiments of the detecting component 118 will not be presented here as the explanation with regard to the detecting component 108 may be similarly applicable here for the detecting component 118.

It should be appreciated that the explanation with regard to the detector module 100 and its corresponding components or features or various embodiments may be similarly applicable to the corresponding like components or features of the detector module 110.

FIG. 1F shows a simplified schematic diagram of the detector module 100 of the embodiment of FIG. 1D. For ease of illustration and clarity purposes, the filter 104, the first chamber 107a, the second chamber 107b and the third chamber 107c of the chip 106 and the first photodetector ‘A1’, the second photodetector ‘B1’ and the third photodetector ‘C1’ of the detecting component 108 are not shown.

As illustrated in FIG. 1F, the first LED 103a emits light with an emission angle, represented by the arrow 130, with the borders of the light emission represented by the dotted lines 132a, 132b. Similarly, the second LED 103b emits light with an emission angle, represented by the arrow 134, with the borders of the light emission represented by the dotted lines 136a, 136b. Accordingly, the first LED 103a and the second LED 103b, are arranged with their emission angles substantially facing each other and the light emission from the first LED 103a substantially overlaps with the light emission from the second LED 103b. Furthermore, such an arrangement enables the first LED 103a and the second LED 103b to be arranged with their directions of light emissions at least substantially facing each other and being at least substantially parallel to the chip 106. Furthermore, in such an arrangement, the light emissions from the first LED 103a and the second LED 103b may be projected onto the chip 106 for illumination of the specimen or specimens, at angles of approximately 15° to 30°. Such an arrangement provides a substantially uniform illumination of the specimen or specimens in the chip 106 across a substantial part along the length of the chip 106.

While the embodiment illustrated in FIG. 1F has been described based on the detector module 100 of the embodiment of FIG. 1D, it should be appreciated that the explanation of the embodiment illustrated in FIG. 1F may be similarly applied to the detector module 110 of the embodiment of FIG. 1E.

FIG. 1G shows a simplified schematic diagram of a detector module 140, according to one embodiment. The detector module 140 includes a light source 142, a chip 144 and a detecting component 146 which may be arranged substantially aligned parallelly with each other. The detector module 140 may include a filter placed in between the light source 142 and the chip 144 and that the chip 144 may include one or more chambers, substantially similar to the configurations of the embodiments of FIGS. 1D and 1E. However, these are not shown in FIG. 1G for ease of illustration and clarity purposes.

The light source 142 includes one LED 148 functioning as the excitation light source to illuminate the specimen or specimens received in the chip 144. The LED 148 may be arranged with its direction of light emission towards the chip 144 and at least substantially perpendicular to the chip 144. In various embodiments, the light emission from the LED 148 onto the chip 144 for illumination of the specimen or specimens may be at an angle of 90° to the chip 144. However, it should be appreciated that the light emission may also be at an angle other than 90° to the chip 144. The LED 148 may be in electrical communication with, for example a power source and/or a control circuit, via an electrical interconnection ‘E1’ (eg. a wire). The LED 148 emits light with an emission angle, represented by the arrow 150, with the borders of the light emission represented by the dotted lines 152a, 152b. The emission angle, represented by the arrow 150, may be relatively large to provide illumination across a substantial part along the length of the chip 144. The LED 148 may be placed in any part of the light source 142, preferably in a substantially central position of the light source 142. It should be appreciated that the LED 148 may have any emission wavelength range and/or emission angle.

The detecting component 146 includes a photodetector 154 configured to detect light emitted from the illuminated specimen. The photodetector 154 may be placed in any part of the detecting component 146, preferably in a substantially central position of the detecting component 146. The LED 148 may be least substantially aligned to the photodetector 154.

In various embodiments, the detector module may include a second LED, where this second LED and the LED 148 may be arranged with their directions of light emissions towards the chip 144 and at least substantially perpendicular to the chip 144, to provide a substantially uniform illumination of the specimen or specimens in the chip 144 across a substantial part along the length of the chip 144. However, it should be appreciated that the light emissions may also be at an angle other than 90° to the chip 144.

FIG. 1H shows a simplified schematic diagram of a detector module 160, according to one embodiment. The detector module 160 includes a light source 162, a chip 164 and a detecting component 166 which may be arranged substantially aligned parallelly with each other. The detector module 160 may include a filter placed in between the light source 162 and the chip 164, similar to the arrangements of the embodiments of FIGS. 1D and 1E but are not shown in FIG. 1H for ease of illustration and clarity purposes. For illustration purposes, the chip 164 includes a first chamber 168a, a second chamber 168b and a third chamber 168c.

The light source 162 includes one LED 170 functioning as the excitation light source to illuminate the specimen or specimens received in the chip 164 or the first chamber 168a, the second chamber 168b and the third chamber 168c of the chip 164. The LED 170 may be arranged with its direction of light emission towards the chip 164 and at least substantially perpendicular to the chip 164. In various embodiments, the light emission from the LED 170 onto the chip 164 for illumination of the specimen or specimens may be at an angle of 90° to the chip 164. However, it should be appreciated that the light emission may also be at an angle other than 90° to the chip 164. The LED 170, may be in electrical communication with, for example a power source and/or a control circuit, via an electrical interconnection ‘E1’ (eg. a wire). The LED 170 emits light with an emission angle, represented by the arrow 172. The emission angle, represented by the arrow 172, may be sufficient to provide illumination of the specimen in one chamber, for example for the second chamber 168b as illustrated in FIG. 1H. In various embodiments, the LED 170 may be movably arranged in the light source 162, as illustrated in FIG. 1H to other positions, for example positions 171a, 171b, in the light source 162 so as to provide illumination of the specimen in the first chamber 168a or the third chamber 168c. This allows the LED 170 to be movable relative to the chip 164 and/or the photodetector 174, for example in a substantially parallel direction to the chip 164 and/or the photodetector 174. Therefore, the LED 170 may be configured to sequentially illuminate the specimens in the first chamber 168a, the second chamber 168b and the third chamber 168c of the chip 164. It should be appreciated that the first chamber 168a, the second chamber 168b and the third chamber 168c may receive the same specimen or that the first chamber 168a may receive a first specimen, the second chamber 168b may receive a second specimen and the third chamber 168c may receive a third specimen. The first specimen, the second specimen and the third specimen may be different specimens.

The detecting component 166 includes one photodetector 174 for detecting the fluorescence or light emitted from the illuminated specimen from one chamber, for example from the second chamber 168b as illustrated in FIG. 1H. In various embodiments, the photodetector 174 may be movably arranged in the detecting component 166, as illustrated in FIG. 1H to other positions, for example positions 175a, 175b, in the detecting component 166 so as to detect the fluorescence or light emitted from the illuminated specimen in the first chamber 168a or the third chamber 168c. This allows the photodetector 174 to be movable relative to the chip 164 and/or the LED 170, for example in a substantially parallel direction to the chip 164 and/or the LED 170. Therefore, the photodetector 174 may be configured to sequentially detect light emitted from the illuminated specimens in the first chamber 168a, the second chamber 168b and the third chamber 168c of the chip 164. It should be appreciated that the first chamber 168a, the second chamber 168b and the third chamber 168c may receive the same specimen or that the first chamber 168a may receive a first specimen, the second chamber 168b may receive a second specimen and the third chamber 168c may receive a third specimen. The first specimen, the second specimen and the third specimen may be different specimens.

In various embodiments, in order for the LED 170 to sequentially illuminate the specimens in the first chamber 168a, the second chamber 168b and the third chamber 168c of the chip 164 and/or for the photodetector 174 to sequentially detect light emitted from the illuminated specimens in the first chamber 168a, the second chamber 168b and the third chamber 168c of the chip 164, the chip 164 may be configured to be movable relative to the LED 170 and/or the photodetector 174, for example in a substantially parallel direction to the LED 170 and/or the photodetector 174.

In various embodiments, any combination of a movable chip 164, a movable LED 170 and a movable photodetector 174, relative to each other, may be provided in the detector module 160.

In various embodiments, any combination of a fixed chip 164 or a movable chip 164, a fixed LED 170 or a movable LED 170 and fixed photodetector 174 or a movable photodetector 174, may be provided in the detector module 160.

In various embodiments, the emission angle, represented by the arrow 172, of the LED 170 may be relatively large to provide illumination across two chambers. In further embodiments, the photodetector 174 may detect the light emitted from the illuminated specimen or specimens from two chambers.

FIG. 1I shows a simplified schematic diagram of a detector module 180, according to one embodiment. The detector module 180 includes a light source 182, a chip 184 and a detecting component 186 which may be arranged substantially aligned parallelly with each other. The detector module 180 may include a filter placed in between the light source 182 and the chip 184, similar to the arrangements of the embodiments of FIGS. 1D and 1E but are not shown in FIG. 1I for ease of illustration and clarity purposes. For illustration purposes, the chip 184 includes a first chamber 188a, a second chamber 188b and a third chamber 188c.

The light source 182 includes a first LED 190a, a second LED 190b and a third LED 190c functioning as the excitation light sources to illuminate the specimen or specimens received in the chip 184. In various embodiments, first LED 190a, the second LED 190b and the third LED 190c may be arranged with their directions of light emissions towards the chip 184 and at least substantially perpendicular to the chip 184. In various embodiments, the light emissions from the first LED 190a, the second LED 190b and the third LED 190c onto the chip 184 for illumination of the specimen or specimens may be at an angle of 90° to the chip 184. However, it should be appreciated that the light emissions may also be at an angle other than 90° to the chip 184. The first LED 190a, the second LED 190b and the third LED 190c, may be in electrical communication with, for example a power source and/or a control circuit, via a first electrical interconnection (eg. a wire) ‘E1’, a second electrical interconnection ‘E2’ and a third electrical interconnection ‘E3’ respectively.

Each of the first LED 190a, second LED 190b and third LED 190c may be aligned to each of the first chamber 188a, second chamber 188b and third chamber 188c of the chip 184 for illuminating the specimens in the first chamber 188a, the second chamber 188b and the third chamber 188c respectively. Each of the first LED 190a, second LED 190b and third LED 190c emits light with an emission angle sufficient to provide illumination of the specimen in one chamber, as illustrated in FIG. 1I. Accordingly, simultaneous illumination of the specimens in the first chamber 188a, the second chamber 188b and the third chamber 188c of the chip 184 may be carried out. It should be appreciated that the first chamber 188a, the second chamber 188b and the third chamber 188c may receive the same specimen or that the first chamber 188a may receive a first specimen, the second chamber 188b may receive a second specimen and the third chamber 188c may receive a third specimen. The first specimen, the second specimen and the third specimen may be different specimens.

The detecting component 186 includes a first photodetector 192a, a second photodetector 192b and a third photodetector 192c for detecting the fluorescence or light emitted from the illuminated specimens in the first chamber 188a, the second chamber 188b and the third chamber 188c respectively. Each of the first photodetector 192a, second photodetector 192b and third photodetector 192c may be aligned to each of the first chamber 188a, second chamber 188b and third chamber 188c of the chip 184 for detecting the light emitted from the illuminated specimens in the first chamber 188a, the second chamber 188b and the third chamber 188c respectively, as illustrated in FIG. 1I. Accordingly, simultaneous detection of the lights emitted from the illuminated specimens in the first chamber 188a, the second chamber 188b and the third chamber 188c of the chip 184 may be carried out. It should be appreciated that the first chamber 188a, the second chamber 188b and the third chamber 188c may receive the same specimen or that the first chamber 188a may receive a first specimen, the second chamber 188b may receive a second specimen and the third chamber 188c may receive a third specimen. The first specimen, the second specimen and the third specimen may be different specimens.

It should be appreciated that the embodiments shown in FIGS. 1F to 1I may be combined with each other to provide further embodiments. For example, in one embodiment, an LED that is movably arranged in a light source may be provided to sequentially illuminate the specimens in the plurality of chambers while a plurality of photodetectors where each photodetector is aligned to each of the plurality of chambers may be provided to detect the light emitted from the illuminated specimen in the respective chamber.

Further, it should be appreciated that the configurations illustrated in the embodiments of FIGS. 1F to 1I or any combinations thereof, may be incorporated with the embodiments of FIGS. 1D and 1E.

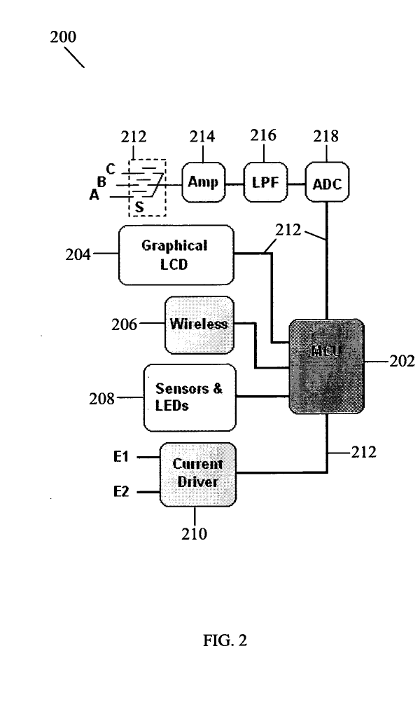

FIG. 2 shows a schematic diagram of a control module 200, according to one embodiment. The control module 200 includes a microcontroller unit (MCU) 202. The control module 200 may further include various components or modules, such as a graphical liquid crystal display (LCD) 204, a wireless module 206, a plurality of sensors and light-emitting diodes (LEDs), represented by the block 208, and a current driver 210. The graphical liquid crystal display (LCD) 204, the wireless module 206, the plurality of sensors and light-emitting diodes (LEDs), represented by the block 208, and the current driver 210, are in electrical communication with the MCU 202, via electrical interconnections (eg. wires), for example as represented by 212, where the MCU 202 may control the operation of these components or modules.

In various embodiments, the graphical liquid crystal display (LCD) 204 may be used, for example, for the display of information. The wireless module 206 in the control module 200 may be used to facilitate exchanges of information to and/or from the control module 200 via a wireless communication protocol.

In various embodiments, the plurality of sensors and light-emitting diodes (LEDs), represented by the block 208, may provide interfaces to sensors, photodetectors or LEDs of the detector module of various embodiments, or of additional peripherals provided with the control module 200 or of external peripherals (not shown). For example, the interface may be provided for indicator LEDs, such as for indicating power, data transmission, data processing, etc.

The current driver 210 is provided to provide current to the light sources and LEDs in, for example, the detector modules 100, 110 (FIGS. 1D and 1E). Accordingly, the MCU 202 controls the first LED 103a and the second LED 103b of the excitation light source 102 via the first electrical interconnection ‘E1’ and the second electrical interconnection ‘E2’ in the case of the detector module 100 (FIG. 1D) or the first LED 113a and the second LED 113b of the excitation light source 112 via the first electrical interconnection ‘E1’ and the second electrical interconnection ‘E2’ in the case of the detector module 110 (FIG. 1E), through the current driver 210. This causes the first LEDs 103a, 113a and the second LEDs 103b, 113b, to emit light having the required wavelengths or wavelength range and intensity to be projected onto the chambers, that may excite the fluorophors in the chambers to emit fluorescence. In various embodiments, the current driver 210 may be a constant current driver.

The control module 200 may further include a switching circuit, S, 212, in electrical communication with the first photodetector ‘A1’, the second photodetector ‘B1’and the third photodetector ‘C1’ of the detector module 100 (FIG. 1D) or the first photodetector ‘A2’, the second photodetector ‘B2’ and the third photodetector ‘C2’ of the detector module 110 (FIG. 1E), for receiving the electrical signals converted from the optical signals in the form of fluorescence detected by the photodetectors. Accordingly, the control module 200 is in electrical communication with the detector module 100, 110, for receiving the electrical signal. In order to sustain a relatively low background noise, and enhance system sensitivity, the optical signals may be purified or refined by suitable excitation and emission filters of specific wavelengths, and a coupler to couple the excitation and emission filters to the photodetectors.

In various embodiments, the electrical signals received are then processed by the control module 200. For example, the electrical signals may be amplified by an amplifier 214, before being passed through a low-pass filter (LPF) 216 and converted into digital signals by an analog-to-digital converter (ADC) 218, to provide ample amplification to ensure stable results while providing a relatively high signal-to-noise ratio.

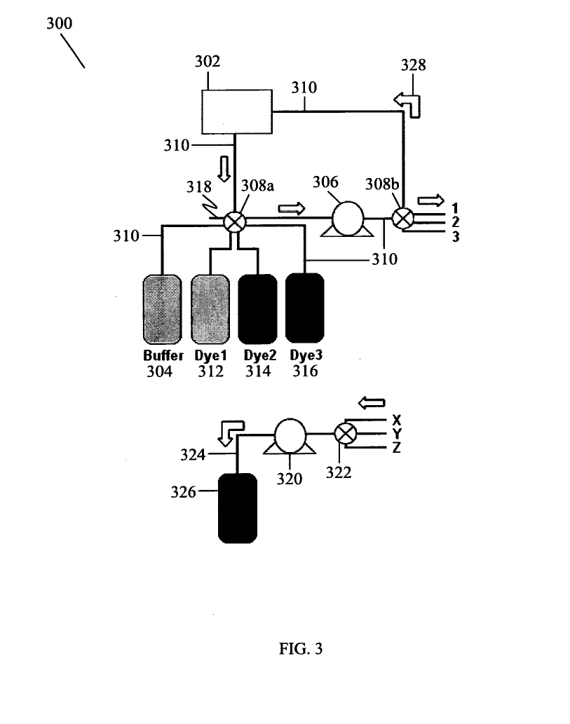

FIG. 3 shows a schematic diagram of a pump module 300, according to one embodiment. The pump module 300 may include a sample collector 302 to collect and hold the sample. The pump module 300 may include a supply of buffer solution 304 which may be pumped by the pump 306 via a first valve 308a and a second valve 308b, and the tubing interconnections, for example as represented by 310, to the sample in the sample collector 302. The buffer solution 304 is provided to maintain a compatible environment for the sample collected in the sample collector 302. The buffer solution 304 may also act as a diluent to the sample. In one embodiment, the buffer solution 304 may be a borate buffer. In another embodiment, the buffer solution 304 may be phosphate buffered saline (PBS).

In various embodiments, a specific amount of the buffer solution 304 may be provided to the sample collector 302 to produce a mixture of the sample and the buffer solution 304 in a specific ratio of approximately 1:1 to form a specimen. The specimen is then pumped by the pump 306 via the first valve 308a and the second valve 308b, and the tubing interconnections, for example as represented by 310, for transfer, for example, to the first chamber 107a, the second chamber 107b and the third chamber 107c of the chip 106 of the detector module 100 (FIG. 1D) or the first chamber 120a, the second chamber 120b and the third chamber 120c of the chip 116 of the detector module 110 (FIG. 1E), via the first tubing interconnection ‘1’, the second tubing interconnection ‘2’ and the third tubing interconnection ‘3’, respectively connected to the respective inlets of the respective chambers.

In order to test and/or detect different analytes or biomarkers or diseases, different dyes may be provided to form different fluorophors with the analytes in the sample. Using the embodiment of FIG. 1D with the chip 106 including the first chamber 107a, the second chamber 107b and the third chamber 107c, and FIG. 3 as an example and not limitations, in order to test 3 different diseases or analytes, 3 different dyes may be provided. Referring to the pump module 300 of FIG. 3, the supply of a first dye 312, a second dye 314 and a third dye 316, may be pumped by the pump 306 via the first valve 308a and the second valve 308b, and the tubing interconnections, for example as represented by 310, to the specimens in the first chamber 107a, the second chamber 107b and the third chamber 107c sequentially. Therefore, multi-detection of different analytes or biomarkers or diseases may be achieved using a single sample per test.

In various embodiments, each of the first dye 312, second dye 314 and third dye 316, may be a fluorogenic dye. The fluorogenic dye may be fluorescamine, epicocconone, o-phthaldialdehyde (OPA), 5,5′-dithiobis-(2-nitrobenzoic acid) (DNTB) or naphthalene-2,3-dicarboxaldehyde (NDA).

It should be appreciated that the pump module 300 may have any number of supplies of dyes, depending on the number of analytes to be detected. For example, the pump module 300 may include between one to eight supplies of dyes such that the number of different dyes provided may be one, two, four, six or eight dyes. In various embodiments, the number of different dyes provided in the pump module 300 may correspond to the number of chambers in the chip in the detector module, where a different analyte is detected in each chamber. For example, if five different types of analytes are to be detected simultaneously, five chambers may be provided in the chip and five different dyes may be provided from the pump module 300 to the chip.

In various embodiments, a different dye may be provided to a different chamber. In further embodiments, all the dyes may be provided to each chamber, either sequentially or simultaneously. In further embodiments, a combination of dyes, for example two or three different dyes, may be provided to, for example one or two chambers, and a different combination of dyes may be provided to another chamber. It should be appreciated that any combination of dyes may be provided to any combination of chambers.

In various embodiments, air intake may also be provided to the pump module 300 via the tube 318. Generally, the amount of sample, buffer or dye provided or transferred from the pump module to the detector module may be small such that air intake is provided to facilitate such a transfer from the pump module to the detector module.

In various embodiments, the pump module 300 may further include a second pump 320 to remove the mixture of buffer solution, sample with analytes or biomarkers and the dyes (ie. the specimens), for example after completion of the test, from the chambers (eg. the first chamber 107a, the second chamber 107b and the third chamber 107c as illustrated in FIG. 1D or the first chamber 120a, the second chamber 120b and the third chamber 120c as illustrated in FIG. 1E) via the valve 322, and the first tubing interconnection ‘X’, the second tubing interconnection ‘Y’ and the third tubing interconnection ‘Z’, respectively connected to the respective outlets of the respective chambers. The mixture is then pumped to the waste collector 326 via the tubing interconnection, for example as represented by 324.

In various embodiments, the first pump 306 and the second pump 320, may be a micropump.

In various embodiments, the arrows shown in FIG. 3 indicate the direction of flow.

In various embodiments, the arrow, as represented by 328 indicates the direction of the flow of the buffer solution 304 provided to the sample collector 302. The buffer solution 304 may be provided to the sample collector 302 to maintain a compatible environment for the sample collected in the sample collector 302 prior to the testing sequence and also to clean the sample collector 302 after the testing sequence.

In various embodiments, the embodiments of the detector modules 100, 110 (FIGS. 1D and 1E), the control module 200 (FIG. 2) and the pump module 300 (FIG. 3) may be arranged to provide either an automated detection system or a portable detection system.

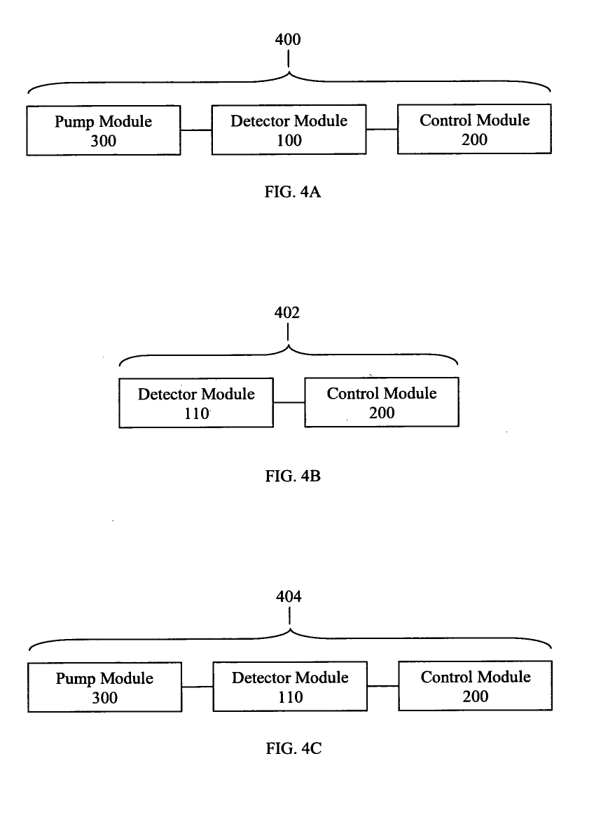

FIG. 4A shows a schematic diagram of an automated detection system 400, according to one embodiment. As an example and not limitations, the automated detection system 400 may include the detector module 100 (FIG. 1D), the control module 200 (FIG. 2) and the pump module 300 (FIG. 3).

FIG. 4B shows a schematic diagram of a portable detection system 402, according to one embodiment. As an example and not limitations, the portable detection system 402 may include the detector module 110 (FIG. 1E) and the control module 200 (FIG. 2).

FIG. 4C shows a schematic diagram of a portable detection system 404, according to one embodiment. As an example and not limitations, the portable detection system 404 may include the detector module 110 (FIG. 1E), the control module 200 (FIG. 2) and the pump module 300 (FIG. 3).

It should be appreciated that any one or some of the modules may be removed from the automated detection system 400, the portable detection system 402 or the portable detection system 404, depending on the applications of the detection system. In addition, one or more of the components in the different modules may be removed (ie. not provided in the different modules) or provided in a separate module. Furthermore, one or more modules or one or more components in different modules may be provided.

It should be appreciated that while the embodiment of FIG. 4A may include the detector module 100 and the embodiments of FIGS. 4B and 4C may include the detector module 110, the configurations as illustrated in the embodiments of FIGS. 1F to 1I or any combinations thereof, may be incorporated with the embodiments of FIGS. 4A to 4C.

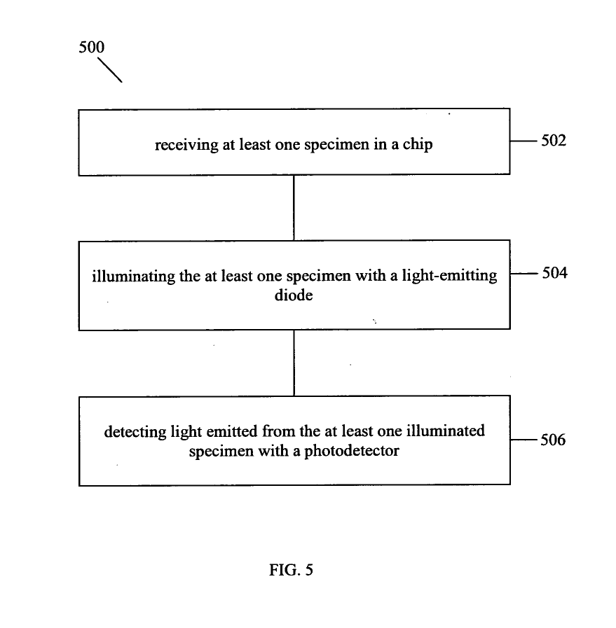

FIG. 5 shows a flow chart 500 illustrating a method for controlling a detector module, according to various embodiments.

At 502, at least one specimen is received in a chip.

At 504, the at least one specimen is illuminated with a light-emitting diode.

At 506, light emitted from the at least one illuminated specimen is detected with a photodetector.

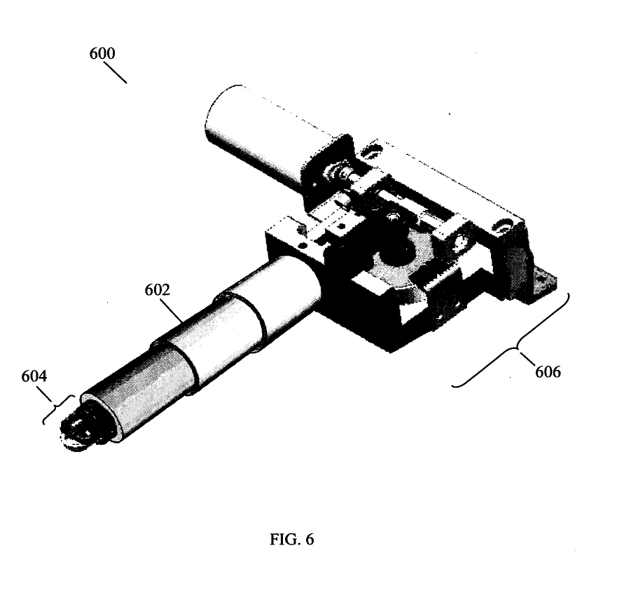

In various embodiments, a sampling system, such as an auto-sampling system which is automated, may be integrated, for example, with the pump module 300 (FIG. 3) to collect a sample. In various embodiments, the auto-sampling system integrated with, for example the pump module 300 (FIG. 3) may also communicate with a detector module, for example the detector module 100 (FIG. 1A) and a control module, for example the control module 200 (FIG. 2). FIG. 6 shows a perspective view of an auto-sampling system 600, according to one embodiment. The auto-sampling system 600 may include a telescopic arm 602, which may be extendable and retractable. The telescopic arm 602 may include a sample holder 604 at one end to collect a sample while the other end of the telescopic arm 602 is coupled to a body 606. The sample holder 604 may have a certain size for collecting a certain amount of sample. In various embodiments, the volume of the sample holder 604 may be approximately 300 μl.

In various embodiments, the telescopic arm 602 may be extended in an outwardly manner to a predetermined position to collect a sample, such as urine. In addition, the telescopic arm 602 may be retracted in an inwardly manner to a storage position, for example in an arm seat provided inside the body 606 of the auto-sampling system 600 in order to minimise contamination.

In various embodiments, the telescopic arm 602 may include a teflon tube inside the telescopic arm 602. The teflon tube may have a diameter of approximately 2 mm. In various embodiments, the teflon tube may be connected to the sample holder 604, such that the teflon tube is in fluid communication with the sample holder 604. The sample may then be pumped, for example, by the pump 306 via the first valve 308a and the second valve 308b (FIG. 3), and the tubing interconnections, for example as represented by 310, to the chip 106 or the first chamber 107a, the second chamber 107b and the third chamber 107c of the chip 106 of the detector module 100 (FIG. 1A), via the first tubing interconnection ‘1’, the second tubing interconnection ‘2’ and the third tubing interconnection ‘3’, respectively connected to the respective inlets of the respective first chamber 107a, second chamber 107b and third chamber 107c. Therefore, the teflon tube may also be considered as being in fluid communication with the chambers, for example the first chamber 107a, the second chamber 107b and the third chamber 107c of the chip 106 of the detector module 100 (FIG. 1A).

In various embodiments, the body 606 may include a motor and/or a gear system for driving the telescopic arm 602 in order to extend or retract the telescopic arm 602. The gear system may be a plastic gear system. In various embodiments, the motor and/or the gear system may be controlled by a microcontroller unit, for example the MCU 202 (FIG. 2) of the control module 200 (FIG. 2) via a wireless signal or command via the wireless module 206 (FIG. 2), compliant with the ZigBee specification.

In various embodiments, when the auto-sampling system 600 is used with the detection system of various embodiments, the sample holder 604 may be equivalent to, for example, the sample collector 302 illustrated in the pump module 300.

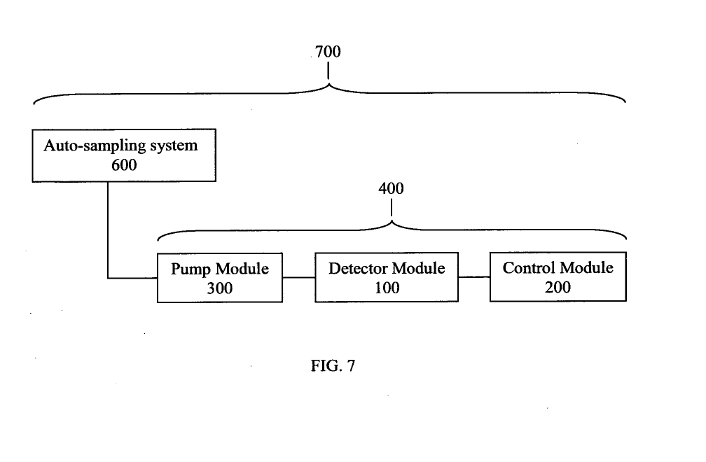

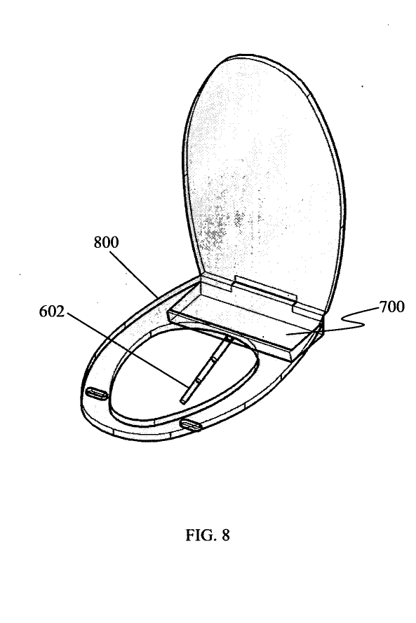

In various embodiments, in order to provide a substantially automated system, for example in the form of an auto-sampling multiplexed detection system, the auto-sampling multiplexed detection system 700 as illustrated in FIG. 7 may include, as an example and not limitations, the automated detection system 400 (FIG. 4A) and the auto-sampling system 600 (FIG. 6). The auto-sampling multiplexed detection system 700 may be provided or integrated with an apparatus or device for collecting a sample. For example, FIG. 8 shows a perspective view of a toilet seat 800 employing the auto-sampling multiplexed detection system 700 having the auto-sampling system 600 (FIG. 6), according to one embodiment. In this case, the auto-sampling multiplexed detection system 700 functions as an auto-sampling multiplexed detection bio-sensing system. As illustrated in FIG. 8, when in operation, the telescopic arm 602 may be extended automatically in an outwardly manner to a predetermined position to collect a sample, which in this case is urine, for testing or processing. The auto-sampling multiplexed detection system 700 may be used to detect analytes of interest, such as proteins, glucose and biomarkers. Detection of different analytes may be achieved by changing the dyes in the pump module 300 (FIG. 3).

It should be appreciated that any one or some of the modules may be removed from the auto-sampling multiplexed detection system 700, depending on the applications of the detection system. In addition, one or more of the components in the different modules may be removed (ie. not provided in the different modules) or provided in a separate module. Furthermore, one or more modules or one or more components in different modules may be provided. For example, for the auto-sampling multiplexed detection system 700, a circuit may be further provided in the control module 200 to control the operation of the auto-sampling system 600, such as driving the motor in the auto-sampling system 600 to extend and retract the telescopic arm 602.

The operation of the auto-sampling multiplexed detection system 700 integrated with the toilet seat 800, based on the embodiment illustrated in FIG. 8, will now be described, by way of examples and not limitations, and with references to FIGS. 1D, 2-3, 4A and 6-8.

In various embodiments, a controller may further be provided to control the auto-sampling multiplexed detection system 700. The controller may communicate with the auto-sampling multiplexed detection system 700 via wireless communication or wired communication. The controller may be, for example, a remote controller in the form of a remote handheld unit or a controller unit provided or integrated with the toilet seat 800.

Using a remote handheld unit as an example, in order to begin a test, a user presses a button (eg. a ‘Start’ button) on the remote handheld unit to start the test. This initiates the test sequence by sending an instruction or command to the control module 200 wirelessly. When the control module 200 has received the command, the control module 200 may send a command via a wireless protocol to the auto-sampling system 600 to turn on the motor in the auto-sampling system 600, thereby causing the telescopic arm 602 including the sample holder 604 to extend in an outwardly manner to a predetermined position to collect the sample (ie. urine).

A fixed amount of urine is collected in the sample holder 604 when the user commences urination. In this example, the sample holder 604 is equivalent to the sample collector 302 as illustrated in the pump module 300.

A specific amount of buffer solution 304 is pumped by the pump 306 via the first valve 308a and the second valve 308b, and the tubing interconnections, for example as represented by 310, to the sample (ie. urine) in the sample collector 302 to produce a specimen of urine and buffer solution 304 at a predetermined ratio, for example at a ratio of 1:1. The specimen is then pumped by the pump 306 via the first valve 308a and the second valve 308b, and the tubing interconnections, for example as represented by 310, to the chip 106 or the first chamber 107a, the second chamber 107b and the third chamber 107c of the chip 106 of the detector module 100, via the first tubing interconnection ‘1’, the second tubing interconnection ‘2’ and the third tubing interconnection ‘3’, respectively connected to the respective inlets of the respective first chamber 107a, second chamber 107b and third chamber 107c.

For detecting 3 different analytes, 3 different detection reagents such as 3 different dyes may be provided. In various embodiments, a first dye 312, a second dye 314 and a third dye 316, are pumped by the pump 306 via the first valve 308a and the second valve 308b, and the tubing interconnections, for example as represented by 310, to the specimens in the chip 106 or the specimens in the first chamber 107a, the second chamber 107b and the third chamber 107c sequentially.

When the first dye 312, the second dye 314 and the third dye 316, have been pumped into the first chamber 107a, the second chamber 107b and the third chamber 107c, each of the first dye 312, the second dye 314 and the third dye 316, will bind to a specific analyte, such as a primary amine present in the urine sample, to form a fluorophor. In various embodiments, the first dye 312, the second dye 314 and the third dye 316 may be provided to each of the first chamber 107a, the second chamber 107b and the third chamber 107c. In various embodiments, the first dye 312 may be provided to the first chamber 107a, the second dye 314 may be provided to the second chamber 107b and the third dye 316 may be provided to the third chamber 107c.

In various embodiments, a pump module may provide a sample, a buffer solution and a respective detection reagent as the respective at least one specimen to each of the at least one chamber of the chip of the detector module. For example, the pump module may provide a first specimen including a sample, a buffer solution and a first detection reagent (eg. a first dye) to a first chamber of the chip, and may provide a second specimen including a sample, a buffer solution and a second detection reagent (eg. a second dye) to a second chamber of the chip, etc.

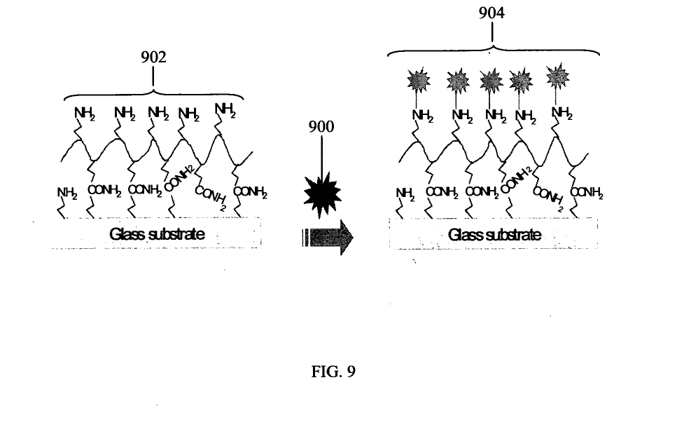

FIG. 9 shows a schematic diagram of a reaction of a dye 900 with an analyte 902 to form a fluorophor 904, according to one embodiment. The dye 900 may be fluorescamine, which itself is non-fluorescent. The analyte 902 may be a primary amine. When illuminated and excited with light at the appropriate excitation wavelength, the fluorophor 904 emits fluorescence. In various embodiments, the first chamber 107a, the second chamber 107b and the third chamber 107c facilitate in maximizing the resultant fluorescence intensity from the fluorophors 904.

In order to excite the fluorophors, the MCU 202 controls and causes the first LED 103a and the second LED 103b to emit excitation lights, via the first electrical interconnection ‘E1’ and the second electrical interconnection ‘E2’ respectively, through the constant current driver 210. The excitation lights with specific wavelengths or wavelength ranges and intensities are projected to the first chamber 107a, the second chamber 107b and the third chamber 107c of the chip 106.

When the specific analyte 902 to be detected is present in the urine sample, the analyte 902 will bind with the dye 900 to form a fluorophor 904 and when subjected to the excitation lights, the fluorophor is induced to emit fluorescence having a distinct wavelength or wavelength range. The wavelength of the fluorescence emitted reflects the identity of the analyte 902. The intensity of the fluorescence emitted is proportional to the concentration of the corresponding target analyte in the sample.

The fluorescence emanating from the first chamber 107a, the second chamber 107b and the third chamber 107c, is collected by the first photodetector ‘A1’, the second photodetector ‘B1’ and the third photodetector ‘C1’ of the detecting component 108. The first photodetector ‘A1’, the second photodetector ‘B1’ and the third photodetector ‘C1’ may be photodiodes (PDs). In various embodiments, the fluorescence optical signals are purified or refined by suitable excitation and emission filters of specific wavelengths to obtain a relatively higher signal-to-noise (S/N) ratio and then converted into electrical signals (eg. currents). The electrical signals are then received by the control module 200, which is in electrical communication with the detector module 100, from each of the first photodetector ‘A1’, second photodetector ‘B1’ and third photodetector ‘C1’ via the switching circuit 212, by switching among the first electrical interconnection ‘A’, the second electrical interconnection ‘B’ and the third electrical interconnection ‘C’ connected respectively to the first photodetector ‘A1’, the second photodetector ‘B1’ and the third photodetector ‘C1’. Subsequently, the signals are amplified by an amplifier 214, passed through a low-pass filter (LPF) 216 and digitized with an analog-to-digital converter (ADC) 218 into its equivalent electrical currents in the opto-electrical system.

The amplifier 214 may be a transimpedance amplifier (TIA) while the LPF 216 may be an 8th order elliptic low-pass filter. The ADC 218 may be a 16-bit delta-sigma ADC to convert the currents received from the first photodetector ‘A1’, the second photodetector ‘1’ and the third photodetector ‘C1’ into digitized voltage levels with ample amplification to provide relatively stable electrical signals or results while providing a relatively high signal-to-noise ratio. The electrical signals are then processed by the MCU 202 and/or displayed on the LCD 204 of the control module 200.

In various embodiments, the first photodetector ‘A1’, the second photodetector ‘B1’ and the third photodetector ‘C1’ are configured in the photovoltaic (PV) mode so as not to introduce any noise current. However, if a high speed response is required, the first photodetector ‘A1’, the second photodetector ‘B1’ and the third photodetector ‘C1’ may be configured in the photoconductive (PC) mode. The photovoltaic (PV) mode and the photoconductive (PC) mode are known in the art as such and will not be described here.

In various embodiments, the control module 200 may also be equipped with a wireless module 206. The wireless module 206 may be compliant with the ZigBee specification. In various embodiments, the control module 200 may be able to transmit electrical signals or commands wirelessly via a wireless protocol via the wireless module 206 to the telescopic arm 602 of the auto-sampling system 600, for example to collect a urine sample, or to the detector module 100 to start the test sequence. In various embodiments, using the wireless module 206, the control module 200 is able to transmit information, for example the test results, wirelessly via a wireless protocol to a processing unit (eg. a PC), a clinical centre (eg. a hospital) or a clinical personnel (eg. a doctor) via the internet or a cell phone. In addition, using the wireless module 206, the control module 200 is able to transmit electrical signals processed by the MCU 202 and/or after digitization by the ADC 218, wirelessly via a wireless protocol to a remote device, such as a handheld unit or a remote controller for the detection system, a display unit, a processing unit, a storage unit or a combination thereof.

In various embodiments, the remote device may be a remote controller for the auto-sampling multiplexed detection system 700, such as a remote handheld unit, or a display unit such as a monitor, a processing unit such as a computer, a storage unit or a combination thereof, where users or medical practitioners may be able to view the test results, for example over the internet, and for further processing, storage, trend plotting and/or display. In various embodiments, the auto-sampling multiplexed detection system 700 may be linked to the database of a healthcare system or a clinical centre where the test results may be accessed by authorized personnel, for example a family doctor, via the internet with password identification.

In various embodiments, upon completion of urine sampling and at the end of the test, the MCU 202 may send a command via a wireless protocol to the auto-sampling system 600 to activate the motor in the auto-sampling system 600 to retract the telescopic arm 602 including the sample holder 604 in an inwardly manner to a storage position, for example in an arm seat provided inside the body 606 of the auto-sampling system 600 to minimise contamination. Subsequently, the buffer solution 304 is pumped by the pump 306 via the first valve 308a and the second valve 308b, and the tubing interconnections, for example as represented by 310, to the sample collector 302 for cleaning the sample collector 302. The buffer solution 304 in the sample collector 302 is then pumped by the pump 306 via the first valve 308a and the second valve 308b, and the tubing interconnections, for example as represented by 310, to the first chamber 107a, the second chamber 107b and the third chamber 107c of the chip 106 for cleaning purposes, via the first tubing interconnection ‘1’, the second tubing interconnection ‘2’ and the third tubing interconnection ‘3’ respectively connected to the respective inlets of the respective first chamber 107a, second chamber 107b and third chamber 107c. After cleaning the first chamber 107a, the second chamber 107b and the third chamber 107c, the buffer solution is then pumped out of the first chamber 107a, the second chamber 107b and the third chamber 107c by the pump 320 via the valve 322, and the first tubing interconnection ‘X’, the second tubing interconnection ‘Y’ and the third tubing interconnection ‘Z’ respectively connected to the respective outlets of the respective first chamber 107a, second chamber 107b and third chamber 107c, as waste. The waste is then pumped by the pump 320 to the waste collector 632 via the tubing interconnection, for example as represented by 324. Accordingly, the auto-sampling multiplexed detection system 700 is cleaned and ready for the next test. The whole process may be automatically controlled and completed by the auto-sampling multiplexed detection system 700 on its own.

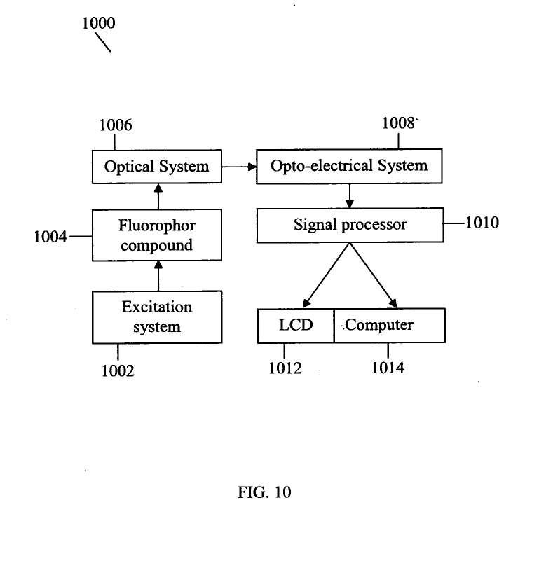

FIG. 10 shows a simplified schematic diagram of a detection and analysis system 1000, based on the auto-sampling multiplexed detection system 700 as an example and not limitations, according to various embodiments. The system 1000 includes an excitation system 1002 for illuminating the specimen containing a fluorophor compound 1004 and inducing fluorescence from the fluorophor compound 1004. The fluorophor compound 1004 may be formed from a reaction between a dye and an analyte. The fluorescence emitted is then detected by an optical system 1006. The fluorescence optical signal is then converted into an electrical signal by an opto-electrical system 1008, before being transmitted to a signal processor 1010. The signal processor 1010 may be provided in a control module. The signal processor 1010 may transmit the raw data or the electrical signal as received or process the electrical signal and then transmit the processed signal to an LCD 1012 for display and/or a computer 1014 for processing or storage. The signal processor 1010 may transmit the electrical signal, as received or processed, either wirelessly via a wireless protocol or a wired connection to the LCD 1012 and/or the computer 1014.

In various embodiments, in order to provide a portable system, for example in the form of a portable multiplexed detection system, the portable detection system 402 (FIG. 4B) may include the detector module 110 (FIG. 1E) and the control module 200 (FIG. 2). The operations of like components, features or modules present in the portable detection system 402 (FIG. 4B) and the auto-sampling multiplexed detection system 700 (FIG. 7), are substantially similar and therefore will not be presented here as the explanation with regard to the like components, features or modules present in the auto-sampling multiplexed detection system 700 (FIG. 7) may be similarly applicable here for the portable detection system 402 (FIG. 4B).

The portable detection system 402 may be used anywhere by the user at their convenience, be it at home, in the office or during their travels. The user may first provide a sample, such as urine, in a disposable container. In this case, the portable multiplexed detection system functions as a portable multiplexed detection bio-sensing system for detecting analytes in the urine sample. In various embodiments, using the portable system 402, the user may then absorb the sample into the chip 116 (FIG. 1E). The chip 116 is then arranged into the detector module 110 (FIG. 1E) and testing may then be carried out. The chip 116 may be a disposable chip or a disposable biochip.

In one embodiment, one or more dyes may be manually provided to the chip 116. In another embodiment, the chip 116 may be pre-coated with one or more dyes for detecting different analytes. In various embodiments, the chip 116 may be pre-coated with antibody for binding to specific analytes, for example when the chip 116 is used for the detection of cancer markers, such as circulating tumour cells (CTCs).

In further embodiments, FIG. 4C shows a portable detection system 404, for example in the form of a portable multiplexed detection system, including the detector module 110 (FIG. 1E), the control module 200 (FIG. 2) and the pump module 300 (FIG. 3). The operations of like components, features or modules present in the portable detection system 404 (FIG. 4C) and the auto-sampling multiplexed detection system 700 (FIG. 7), are substantially similar and therefore will not be presented here as the explanation with regard to the like components, features or modules present in the auto-sampling multiplexed detection system 700 (FIG. 7) may be similarly applicable here for the portable detection system 404 (FIG. 4C).

The portable detection system 404 may be used anywhere by the user at their convenience, be it at home, in the office or during their travels. In one embodiment, the user may first provide a sample, such as urine, in a disposable container. The user may then absorb the sample into the chip 116 (FIG. 1E). The chip 116 is then arranged into the detector module 110 (FIG. 1E). The chip 116 may be a disposable chip or a disposable biochip. The subsequent processes may then be automated, such as providing one or more dyes from the pump module 300 to the chip 116, and the testing sequences.

In another embodiment, the portable detection system 404 may further include the auto-sampling system 600 (FIG. 6) integrated with the pump module 300 to provide an automated portable detection system. In this embodiment, the sample may be collected by the auto-sampling system 600 and then transferred by the pump module 300 to the chip 116 (FIG. 1E). The chip 116 may be a disposable chip or a disposable biochip.

It should be appreciated that the detection system of various embodiments may be battery powered or operated via the mains electricity.

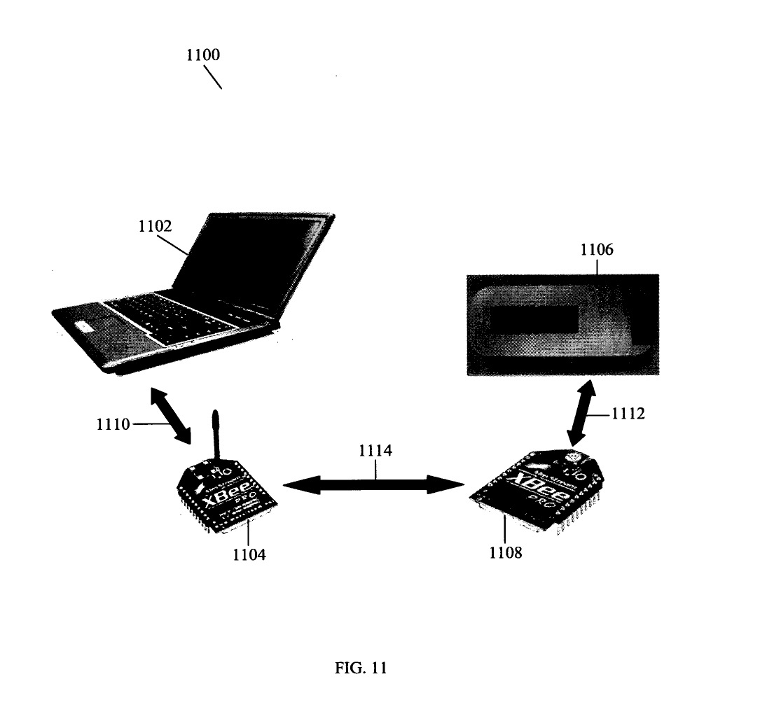

FIG. 11 shows a schematic view of an information system 1100, according to various embodiments. The information system 1100 may be a wireless password-secure information system and may be used for the signal processing, display, storage, dissemination and access of the test results. The information system 1100 may be used for controlling and communicating with the detection system of various embodiments, for example a battery powered bio-sensing detection system.

As an example and not limitations, the battery powered bio-sensing detection system may include one or more of the following components and features, depending on the usage and applications:
An auto-sampling system.
A micro-fluidic control system.
An excitation light module.
An optoelectrical converter module.
A micro-controller for collecting raw data and analyzing the data.
An alphanumeric segment LCD panel for display.
A 4 way directional keypad for navigation control (eg. for operating/configuring the detection system).
Allows users to select diagnostic profiles and user names.
Quick test one touch operation.
General purpose LEDs for different indications such as power indicator, for indicating operations or processes of acquiring sample, diagnostic, completion of test, etc.

In various embodiments, the information system 1100 may include a computer or a laptop 1102 with a suitable graphical user interface (GUI), an XBee Pro module 1104 for communication or connectivity to the laptop 1102 and a portable handset unit or a remote controller 1106 with an embedded XBee Pro module 1108 for wireless connectivity or communication with the laptop 1102 via the XBee Pro module 1104.

In various embodiments, the XBee Pro module 1104 may be embedded with the laptop 1102. In further embodiments, the XBee Pro module 1104 may be a stand-alone module communicating with the laptop 1102. The communication between the laptop 1102 and the XBee Pro module 1104, as represented by the arrow 1110, may either be via a wireless protocol or via a connection using a serial interface or a Universal Serial Bus (USB) to the laptop 1102. In various embodiments, the communication, as represented by the arrow 1112, between the embedded XBee Pro module 1108 and the portable handset unit 1106 may be via a universal asynchronous receiver/transmitter (UART) interface.

In various embodiments, the communication, as represented by the arrow 1114, between the XBee Pro modules 1104, 1108 may be via a wireless protocol compliant with the ZigBee specification based on the IEEE 802.15.4 standard, to allow wireless data transmission between the laptop 1102 and the portable handset unit 1106.

In various embodiments, the portable handset unit 1106 may be used to provide user interface, to collect data, store data, display data and/or as a transceiver unit.

In various embodiments, the software or program used on the computer or laptop 1102 may include one or more of the following features:
A user-friendly graphical user interface (GUI).
Allows multiple user names to be created and edited. One, two, three, four, five, six or more user names may be created. Password identification may be provided for each user name.
Allows downloading of the user names to a remote device (eg. remote controller 1106) via a communication protocol compliant with the ZigBee specification.
Allows new diagnostic profiles to be created and edited for each user.
Allows downloading of diagnostic profiles to a remote device (eg. remote controller 1106) via a communication protocol compliant with the ZigBee specification.
Allows uploading of diagnostic results and/or profiles from a remote device (eg. remote controller 1106) via a communication protocol compliant with the ZigBee specification.
Allows user names, diagnostic profiles and results to be stored in a database or accessed from a database.
Perform trend and statistic analysis.
Produce alerts for users though an alert logging system.
Provides a direct communication to the XBee Pro module (eg. the XBee Pro module 1104), for example though a serial communication port.
Organising the test reports or results in a suitable manner for access with password control and/or uploading to a database residing on a server in a relatively easy manner. The access may be a remote access.

In various embodiments, Electrically Erasable Programmable Read-Only Memory (EEPROM) may be used to store the users' test results and records. The EEPROM may be embedded with the laptop 1102, the remote controller 1106 or may be an external EEPROM.

In various embodiments, each test record may require 10 bytes for storage purposes. Table 1 shows the breakdown of the usage of 10 bytes for storing different data.

TABLE 1
Storage of test record

| | | Bytes |
|---|---|---|
| Data | Description | required |
| Date | Format: DDMMYY. | 3 |
| | Day (DD) represented in 1 Byte. | |
| | Month (MM) represented in 1 Byte. | |
| | Year (YY) represented in 1 Byte. | |
| Time | Format: HH:MM:SS | 3 |
| | Hour (HH) represented in 1 Byte. | |
| | Minute (MM) represented in 1 Byte. | |
| | Second (SS) represented in 1 Byte. | |
| User name | Each user has a corresponding user ID. | 1 |
| identification | Using 1 Byte (equivalent to 8 bits), there can | |
| (ID) | be a total of 256 (equivalent to 2⁸) different users. | |
| Test ID | Each test ID corresponds to a particular | 1 |
| | diagnostic test. | |
| | Using 1 Byte, there can be a total of 256 different | |
| | test types. | |
| Test result | Test result presented in numerical number in | 2 |
| | mg/ml unit. For example, the test result for | |
| | protein may provide readings in the form of | |
| | ‘0.15-0.3 mg/ml’. | |

In various embodiments, based on the storage of test record outlined in Table 1, the requirements of the EEPROM are as follows:
1 record requires 10 bytes.
Certain tests, such as a globulin test, may require each user to test every 4 hours, which is equivalent to a total of 6 records per day. This translates to a maximum of 60 bytes per test sequence per day.
Based on the assumption that each user may perform 3 different types of test sequences per day, the requirements amount to 180 bytes per user per day (3×60 bytes).
Based on the assumption that there may be 6 users per family (eg. the grandparents, the parents and 2 children), the requirements amount to 1080 bytes of storage per day (6×180 bytes).
Based on the assumption that one week of trend monitoring is performed, a total of 7560 bytes (7×1080 bytes) is required.

In various embodiments, accordingly, 8 kB of EEPROM may be provided. However, it should be appreciated that a higher amount of storage may be provided to cater for expansion, for example to accommodate more users or more tests to be carried out or a longer period of trend monitoring.

In one embodiment, the EEPROM used may be the ‘24AA1025’ CMOS

EEPROM with Inter-Integrated Circuit (I²C) Interface by Microchip Technology. The ‘24AA 1025’ EEPROM has a density of 1024 kbit and a clock frequency of 400 kHz.

In various embodiments, the MCU provided in the detection system of various embodiments may have the following pin requirements as shown in Table 2.

TABLE 2
MCU pin requirements

| | Number of | |
|---|---|---|
| Components | pin interface | Pin description |
| Detector Circuit | 2 | Analog-to-digital converter (ADC) |
| (for example | | |
| SPM (a | | |
| photodiode by | | |
| Hamamatsu), | | |
| Transimpedance | | |
| amplifier (TIA) | | |
| & Filter) | | |
| XBee Pro Module | 2 | Digital Input (DI) + Digital Output |
| | | (DO) (UART) |
| EEPROM | 2 | Data line (SDA) + Clock line |
| (24AA1025) | | (SCL) (I²C) |
| 4-MUX | 34 | Segment voltage and common |
| (multiplexed) | | voltage (LCD Driver) |
| Segment LCD | | |
| Power control | 1 | On/Off switching of integrated |
| (PNP Transistor) | | circuits (ICs) |
| Sensors | 2 | Detection of biochip and detection of |
| | | sample |
| Push Buttons | 6 | Up, Down, Select, Enter, Reset, |
| | | Power On/Off |
| General Purpose | 2 | Power, Transmit/Received (Tx/Rx), |
| LEDs | | Process Indicator (eg. indicating that |
| | | the chip is inserted, waiting for |
| | | sample, acquiring test results, etc) |
| Total Pin Count | 51 | |

In various embodiments, the MCU provided in the detection system of various embodiments may also have one or more of the following features:
1 UART interface for data communication.
1 A/D pin for analog-to-digital converter.
1 LCD driver for a display unit (eg. an LCD).
13 General Purpose Input/Output (GPIOs) for interfacing with devices and/or peripherals (for example for the push buttons, general purpose LEDs, power control, I²C interface, Sensor, etc.).

In one embodiment, the MCU used may be the ‘MSP430F4794’ microcomputer by Texas Instruments, having the following features:
60 KB+256B Flash Program Memory.
2.5 KB RAM.
16-Bit Reduced Instruction Set Computing (RISC) Architecture.
Four independent 16-bit Sigma-Delta Analog-to-Digital (A/D) converters.
Two 16-Bit timers.
One LCD Driver for 160 Segments.
Two Universal Synchronous/Asynchronous Receiver/Transmitter (USART) interfaces.
Two Serial Peripheral Interface/Universal Asynchronous Receiver/Transmitter (SPI/UART) interfaces.
100 pins with a maximum of 72 Input/Output (I/O) pins.

The pins of the ‘MSP430F4794’ microcomputer may be allocated according to the pin requirements as shown in Table 3.

TABLE 3
MCU pin allocation

| Essential Pin allocation | Number of Pins |
|---|---|
| ADC x1 | 3 |
| LCD Driver | 38 |
| I²C interface | 2 |
| UART interface | 2 |
| Power supply (Vcc/Vss) | 6 |
| NC (ie. Not connected) | 13 |
| Reset | 1 |
| Crystal Oscillator | 2 |
| Total number of pins | 67 |
| Available free pins | 100 − 67 = 33 |

As there are 33 available free pins, some of these free pins may be used for GPIOs. For example, 13 of these pins may be used for GPIOs as per the requirements outlined above.

The fluorescence from solutions of different concentrations containing analytes were measured and recorded using the detection system of various embodiments. All measurements were made in triplicates.

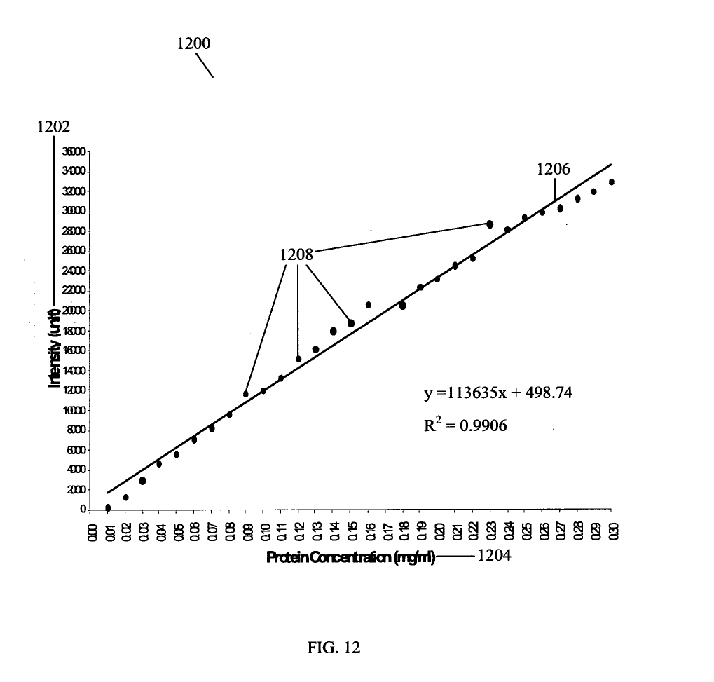

FIG. 12 shows a plot 1200 of protein concentration (which in this case is the bovine serum albumin (BSA)) and the fluorescence intensity, according to various embodiments. The plot 1200 illustrates the variation of the intensity 1202 of the fluorescence as a function of the BSA concentrations 1204 in the range of between about 0.01 to about 0.3 mg/ml. The results in FIG. 12 show that the intensity 1202 increases with an increase in the BSA concentration 1204.

The line 1206 represents a linear fit through the data points, for example as represented by 1208 for four of the data points, and may be indicated as a linear relationship having the empirical equation y=113635x+498.74 and a square of the correlation coefficient, R², having a value of 0.9906, thereby indicating good linear reliability of the linear relationship.

The linear relationship between the fluorescence intensity 1202 and the BSA concentration 1204 indicates that the measured fluorescence signal results from the specific interaction of the dye, which in this case is fluorescamine, with the BSA.

FIG. 12 also shows that detection is possible for a concentration level down to approximately 0.015 mg/ml, which is one decade lower than the target concentration of about 0.15 mg/ml sufficient for normal clinical screening tests.

In addition, results observed also show that the fluorescence intensity increases linearly with an increase in the power of the excitation light sources, thereby increasing the sensitivity of the detection system.

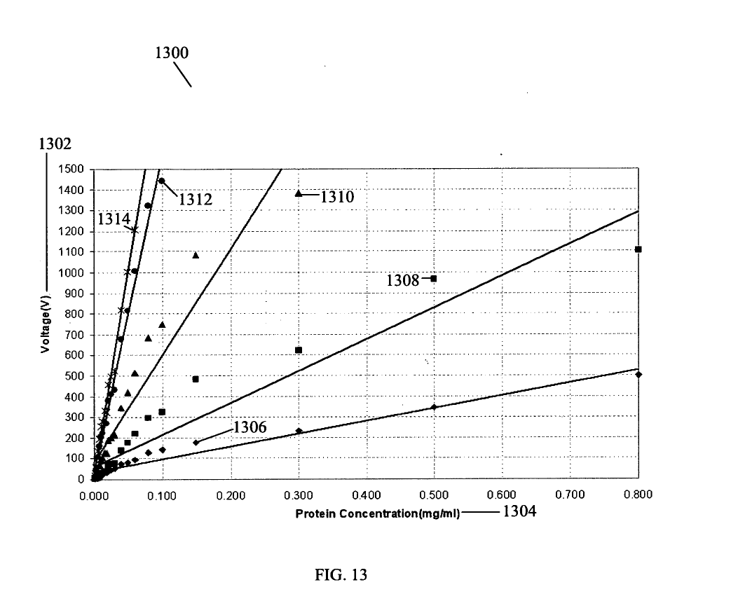

FIG. 13 shows a plot 1300 of protein concentration (which in this case is the bovine serum albumin (BSA)) and voltage, according to various embodiments. The plot 1300 illustrates the variation of the voltage 1302, which is the converted electrical signal by the photodetectors in the detected system of various embodiments from the fluorescence received by the photodetectors, as a function of the BSA concentrations 1304 in the range of between about 0.0 mg/ml to about 0.8 mg/ml.

In various embodiments, as the photodetectors in the detector system of various embodiments may convert the fluorescence received into electrical signals (eg. a voltage), the level of the voltage 1302 may indicate the level of the fluorescence intensity. A high level of fluorescence intensity detected and received by the photodetectors may correspond to a high level of voltage 1302.

FIG. 13 shows the results obtained using a conventional photometer (♦ data points, for example as represented by 1306 for one such data point), and the detection system of various embodiments with the excitation light source (eg. LED) driven at about 5 mA (▪ data points, for example as represented by 1308 for one such data point), about 10 mA (▴ data points, for example as represented by 1310 for one such data point), about 20 mA ( data points, for example as represented by 1312 for one such data point) and about 25 mA (x data points, for example as represented by 1314 for one such data point). The respective linear fit is shown as a guide for the respective data points.

The results in FIG. 13 show that the voltage 1302, and consequently the fluorescence intensity, increases with an increase in the current, and consequently the power, of the excitation light source of the detection system of various embodiments. Therefore, the results in FIG. 13 also indicates that the sensitivity of the detector system of various embodiments is proportional to the intensity of the excitation light sources (eg. the LEDs).

In various embodiments, a relatively high signal to noise ratio, or high sensitivity, would be advantageous so that relatively small changes in the fluorescence of bio-samples may be discerned with a relatively high accuracy.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A detector module, comprising:
a chip configured to receive at least one specimen;
a first light-emitting diode configured to illuminate the at least one specimen; and
a first photodetector configured to detect light emitted from the at least one illuminated specimen.

2. The detector module as claimed in claim 1, wherein the chip is detachably arranged in the detector module.

3. The detector module as claimed in claim 1, wherein the chip comprises at least one chamber configured to receive the at least one specimen.

4. The detector module as claimed in claim 1, wherein the chip comprises a plurality of chambers, wherein each chamber of the plurality of chambers is configured to receive the at least one specimen.

5. (canceled)

6. The detector module as claimed in claim 4, wherein the first light-emitting diode is configured to sequentially illuminate the at least one specimen in the plurality of chambers of the chip.

7. The detector module as claimed in claim 4, wherein the first photodetector is configured to sequentially detect light emitted from the at least one illuminated specimen in the plurality of chambers of the chip.

8. The detector module as claimed in claim 1, wherein the chip is movable relative to the first light-emitting diode and/or the first photodetector.

9. The detector module as claimed in claim 1, wherein the first light-emitting diode is movable relative to the chip and/or the first photodetector.

10. The detector module as claimed in claim 1, wherein the first photodetector is movable relative to the chip and/or the first light-emitting diode.

11. (canceled)

12. The detector module as claimed in claim 1, wherein the detector module further comprises a second light-emitting diode configured to illuminate the at least one specimen.

13. The detector module as claimed in claim 12, wherein the first and second light-emitting diodes are arranged with their directions of light emissions at least substantially perpendicular to the chip.

14. (canceled)

15. The detector module as claimed in claim 12, wherein the first and second light-emitting diodes are arranged with their directions of light emissions at least substantially facing each other and being at least substantially parallel to the chip.

16. The detector module as claimed in claim 12, wherein the detector module further comprises a third or more light-emitting diodes configured to illuminate the at least one specimen.

17. The detector module as claimed in claim 1, wherein the detector module further comprises a second or more photodetectors configured to detect light emitted from the at least one illuminated specimen.

18. (canceled)

19. The detector module as claimed in claim 1, wherein the photodetector is configured to convert the light emitted from the at least one illuminated specimen and received by the photodetector into an electrical signal.

20. A detection system, comprising:
a detector module as claimed in claim 19; and
a control module in electrical communication with the detector module, wherein the control module is configured to receive the electrical signal.

21. The detection system as claimed in claim 20, wherein the control module is configured to transmit the electrical signal wirelessly to a remote device.

22-23. (canceled)

24. The detection system as claimed in claim 20, further comprising a pump module configured to collect a sample.

25. The detection system as claimed in claim 24, further comprising a sampling system integrated with the pump module, wherein the sampling system is configured to collect the sample.

26-27. (canceled)

28. The detection system as claimed in claim 24, wherein the pump module is further configured to provide a detection reagent to the chip.

29-37. (canceled)
